(19) United States
(12) Patent Application Publication
(10) Pub. No.: US 2002/0002523 A1
(43) Pub. Date: Jan. 3, 2002

(54) Online patent and license exchange

(76) Inventors: Nir Kossovsky, Pasadena, CA (US); Bear Brandegee, Pasadena, CA (US); Alexander K. Arrow, Los Angeles, CA (US)

Correspondence Address: Roberta P. Saxon, Skjerven Morrill MacPherson LLP, 25 Metro Drive, Suite 700, San Jose, CA, 95110, US

(21) Appl. No.: 09/839,844

(22) Filed: Apr. 20, 2001

Related U.S. Application Data
(63) Continuation of application No. 09/665,187, filed on Sep. 16, 2000.
Application No. 09/665,187 is a continuation-in-part of application No. 09/580,005, filed on May 26, 2000.
Application No. 09/580,005 is a continuation-in-part of application No. 09/371,614, filed on Aug. 10, 1999.
(60) Provisional application No. 60/124,847, filed on Mar. 17, 1999.

(51) Int. Cl. G06F 17/60

(52) U.S. Cl. 705/36; 705/35; 705/37

(57) ABSTRACT

An online patent and license exchange is provided which enables potential licensors and licensees of patents and other intellectual property rights to efficiently and reliably transact IP license or assignment agreements. The online patent and license exchange includes a method of providing a valuation of an IP asset using data from companies in a similar technology classification as the IP asset, a method of generating a suggested IP asset asking price, an index of IP market value according to technology classification, a method for quantifying the financial risk of an asset (β), and a quantitative database of technology attributes of IP assets. The valuation is also used in valuing IP assets to provide insurance for sale transactions, in securitization, collateralization, and donation for tax purposes of IP assets, and in prioritization of assets in an IP portfolio.

### CROSS-REFERENCE TO RELATED APPLICATIONS

The present application is a continuation-in-part of U.S. patent application Ser. No. 09/580,005, filed May 26, 2000, which is a continuation-in-part of U.S. patent application Ser. No. 09/371,614, filed Aug. 10, 1999, which claims priority from provisional patent application Ser. No. 60/124,847, filed on Mar. 17, 1999.

### BACKGROUND OF THE INVENTION

1. Field of the Invention

The present invention relates generally to electronic commerce and, more particularly, to electronic commerce of intellectual property rights.

2. Related Art

Effective licensing of intellectual property (IP) rights and, in particular, patent rights, presents unique challenges due to the complexity of the laws regulating the acquisition and enforcement of IP rights on the one hand and the intricacies of evaluating the potential values of the emerging technologies sought to be protected by the IP rights on the other. Patent rights, for example, require formal application and evaluation proceedings (patent prosecution) in the United States patent and Trademark Office that may last for several years. Under current laws, a patent grants its owner a limited monopoly in the patented invention starting on the date the patent is granted for a term of 20 years from the filing date of the patent application. Thus, the effective patent term may be significantly shorter than the 20 year term set by the statute.

Furthermore, inventors are often not interested or not able to exploit patented technologies on their own, but rather prefer to license their rights to third parties for commercial development. However, patents often issue before a market has been established for the technology protected by the patents, making the process for establishing reasonable terms for patent licensing rather complicated. In the prior art, the process of licensing patent rights requires, on average, a significant portion of the patent term, thereby limiting the amount of revenue generated by patent rights. According to one study, the patent licensing process requires, on average, 37 months. Since patent prosecution requires on average 2-3 years, between a quarter and third of the statutory patent term may be lost for licensing purposes under current patent licensing practices.

Several factors contribute to the inefficiency of current patent licensing practices including, but not limited to, the difficulty of matching inventors and other potential patent licensors with interested and qualified potential patent licensees, the intricacies of determining an accurate market value for the patented technology and the lack of an efficient infrastructure for the secure transfer of intellectual property rights.

There is thus a need for a more efficient and reliable system for licensing or assigning patent and other intellectual property rights.

### SUMMARY OF THE INVENTION

The method and apparatus of the present invention provide an online patent and license exchange which enables potential licensors and licensees of patents and other intellectual property rights to efficiently and reliably transact IP license or assignment agreements. Three markets are part of the exchange: a license market, an options market and a securitized asset cash flows market. The markets of the online patent and license exchange comprise three integrated components: information, transaction, and fulfillment. Information is exemplified by a comprehensive database of IP rights offered for licensing on the exchange, including a reliable market estimation of the both the value and relative financial riskiness (β) of each IP asset listed on the exchange. Transaction is exemplified by a price discovery mechanism and transaction closing service; fulfillment is exemplified by a patent and royalty insurance service and an escrow service.

A method of providing a valuation of an IP asset, according to the present invention, is based on call option pricing theory and uses information about the IP asset and data from publicly traded companies in a same technology classification as the IP asset. Information about the IP asset includes estimated cost and time to commercialize a product based on the technology of the IP asset and remaining term of a central patent. The invention further includes a method of generating a suggested asking price for an IP asset using the valuation and specified licensing terms. A discount flag may be displayed when a seller chooses an offering price that is lower than the suggested asking price.

The valuation is also used in determining the amount of patent validity insurance provided in the sale of an IP asset. Further, the valuation can be used for securitization and collateralization of an IP asset, for valuing an IP asset for tax donation purposes, and in prioritizing assets in an IP portfolio for management decisions.

In another aspect, the invention includes an index of market value of intellectual property belonging to a technology classification. The index for each classification uses enterprise values of publicly traded companies operating within the classification. The index is useful for generating a relative measure of financial risk (β). Finally, a Quantitative Asset Database for storing quantitative information about attributes of technology described by an IP asset is also provided. A translator for converting between international scientific units and user defined units is included as part of the process of storing information in the Quantitative Asset Database.

### BRIEF DESCRIPTION OF THE DRAWINGS

FIG. 1 is a block diagram of a computer system in accordance to an embodiment of the invention.

FIG. 2A is a block diagram of the hardware/software structure of the client computers of FIG. 1.

FIG. 2B is a block diagram of the hardware/software structure of the server computer of FIG. 1.

FIG. 3 is a flow diagram of an exchange operation of the server program of FIG. 2B.

FIG. 4 is a flow diagram of an auction operation of the server program of FIG. 2B.

FIGS. 5A-5C illustrates patent information pages displayed by the web browser of FIG. 2A on a screen of a client computer during operation of the computer system of FIG. 1.

FIG. 6 illustrates a search menu page displayed by the web browser of FIG. 2A on a screen of a client computer during operation of the computer system of FIG. 1.

FIGS. 7A and 7B illustrate a search page displayed by the web browser of FIG. 2A on a screen of a client computer during operation of the computer system of FIG. 1.

FIG. 8 illustrates a search results page displayed by the web browser of FIG. 2A on a screen of a client computer during operation of the computer system of FIG. 1.

FIG. 9 illustrates a results information page displayed by the web browser of FIG. 2A on a screen of a client computer during operation of the computer system of FIG. 1.

FIG. 10 illustrates a bid page displayed by the web browser of FIG. 2A on a screen of a client computer during operation of the computer system of FIG. 1.

FIG. 11 illustrates an auction status page displayed by the web browser of FIG. 2A on a screen of a client computer during operation of the computer system of FIG. 1.

FIG. 12 illustrates a bid details page displayed by the web browser of FIG. 2A on a screen of a client computer during operation of the computer system of FIG. 1.

FIG. 13 illustrates a message board page displayed by the web browser of FIG. 2A on a screen of a client computer during operation of the computer system of FIG. 1.

FIG. 14 is a block diagram of the exchange enabled by the computer system of FIG. 1.

FIG. 15 is a flow diagram of an alternative embodiment of part of the exchange operation of FIG. 3.

FIGS. 16A and 16B illustrate trademark and copyright information loading pages displayed by the web browser of FIG. 2A on a screen of a client computer during operation of the computer system of FIG. 1.

FIGS. 17A-17C are detailed flow diagrams of the process stages of FIG. 15.

FIGS. 18A-18D illustrate basic, legal, financial, and licensing information loading pages, respectively, and FIG. 18E illustrates an input page for the Quantitative Asset Database, all pages displayed by the web browser of FIG. 2A on a screen of a client computer during operation of the computer system of FIG. 1.

FIG. 19 illustrates an input screen for a pricing calculation displayed by the web browser of FIG. 2A on a screen of a client computer during operation of the computer system of FIG. 1.

FIG. 20 illustrates a price calculation page displayed by the web browser of FIG. 2A on a screen of a client computer during operation of the computer system of FIG. 1.

FIG. 21 illustrates results of a price calculation displayed by the web browser of FIG. 2A on a screen of a client computer during operation of the computer system of FIG. 1.

FIG. 22 illustrates an additional input screen for a pricing calculation displayed by the web browser of FIG. 2A on a screen of a client computer during operation of the computer system of FIG. 1.

### DETAILED DESCRIPTION OF THE INVENTION

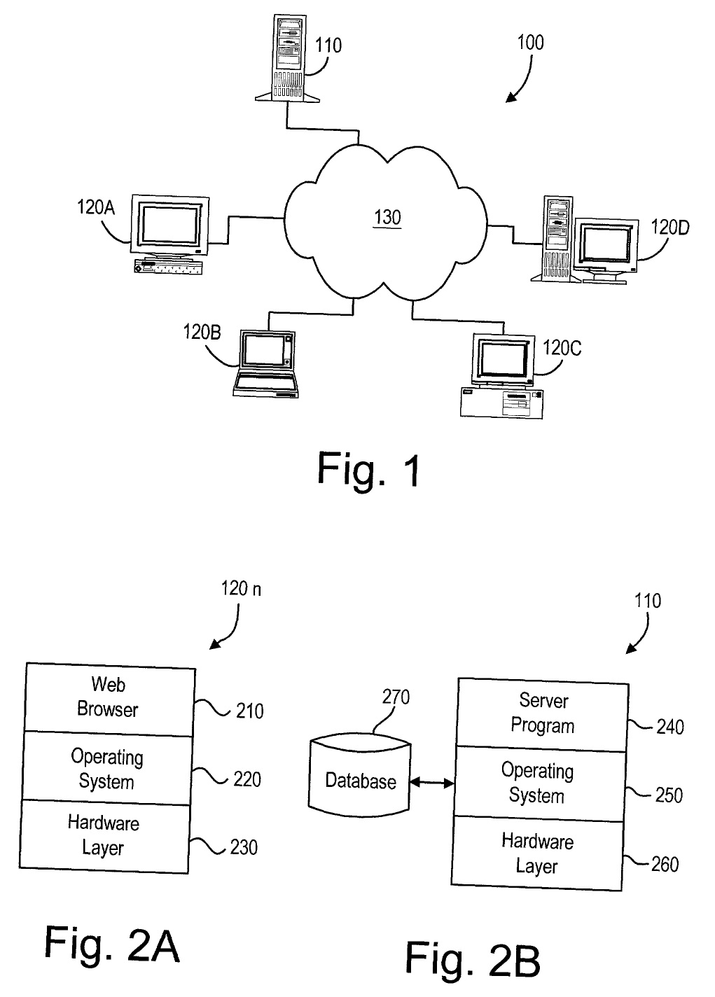

A computer system 100, according to an embodiment of the invention is shown in FIG. 1. Computer system 100 includes a server computer 110 and a plurality of clients 120n (where n=A, B, C, D, etc.) connected via global-area network (e.g., the Internet) 130.

FIG. 2A illustrates the hardware/software structure of a client computer 120n. During operation of computer system 100, a web browser program 210 is executed on top of operating system 220, which in turn controls hardware layer 230. Hardware layer 230, in turn, provides a physical connection to global-area network 130.

FIG. 2B illustrates the hardware/software structure of server computer 110. During operation of computer system 100, server program 240 is executed on top of operating system 250, which in turn controls hardware layer 260. Hardware layer 260, in turn, provides a physical connection to global-area network 130. Server program 240 also stores and retrieves information in database 270 via operating system 250.

Users of computer system 100 access the patent and license exchange of the present invention via a client computer 120n. Web browser program 210 first establishes a connection to server program 240 over global-area network 130. Users can then access a website for the patent and license exchange via web browser program 210, server program 240 and database 270.

Server computer 110 can be any special or general purpose computer suitable for maintaining a website such as a Pentium-based computer, available from a variety of third parties, an UltraSparc workstation, available from Sun Microsytems, Inc. of Mountain View, Calif., an RS6000 workstation, available from IBM of New York, etc. Client computers 120n can be any special or general purpose computer suitable for accessing a website over the Internet, such as any a Pentium-based computer, available from a variety of third parties, a Macintosh computer, available from Apple Computer, Inc. of Cupertino, Calif., etc.

Operating systems 220 and 250 are any suitable operating system for controlling client computers 120n and server computer 110 such as Windows98, Windows NT 4.0 or Windows2000, available from Microsoft Corp. of Redmond, Wash., MacOS 8.5, available from Apple Computer, Inc., any version of the Unix operating system, etc.

Web browser program 210 is any web browser program such as Internet Explorer 5.0, available from Microsoft Corp. or Netscape Navigator, available from Netscape Communications of Mountain View, Calif.

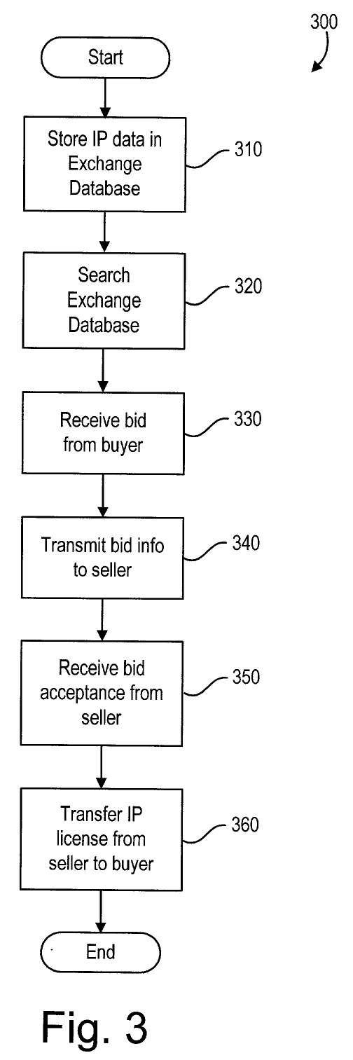

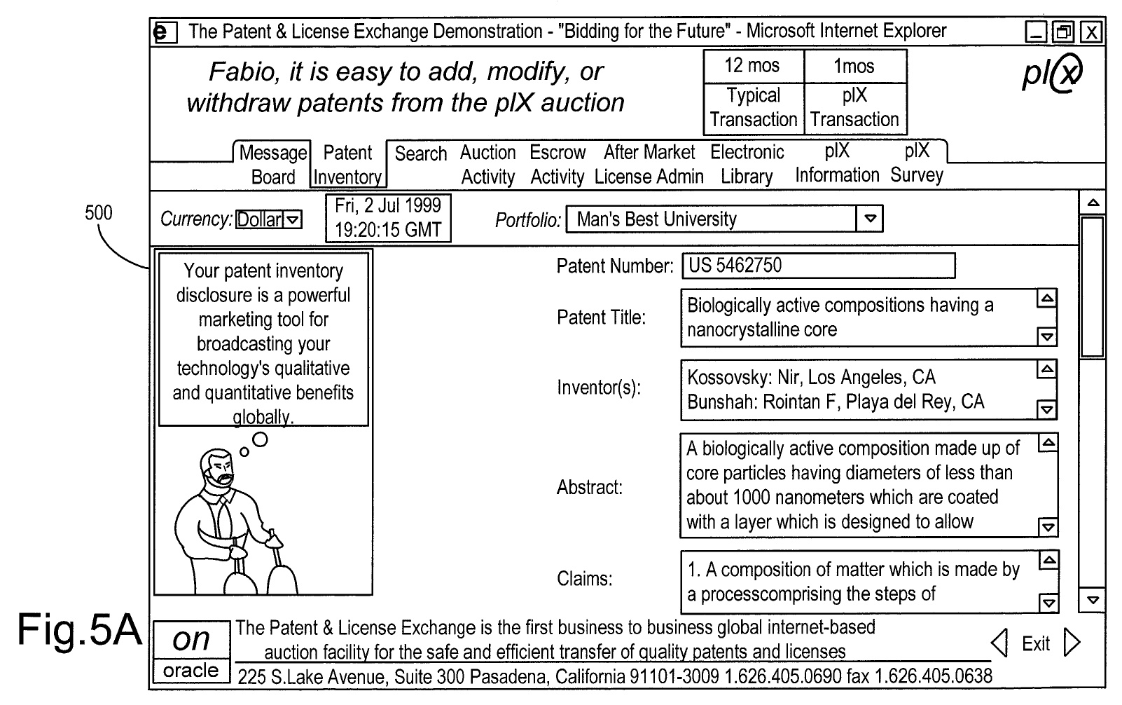

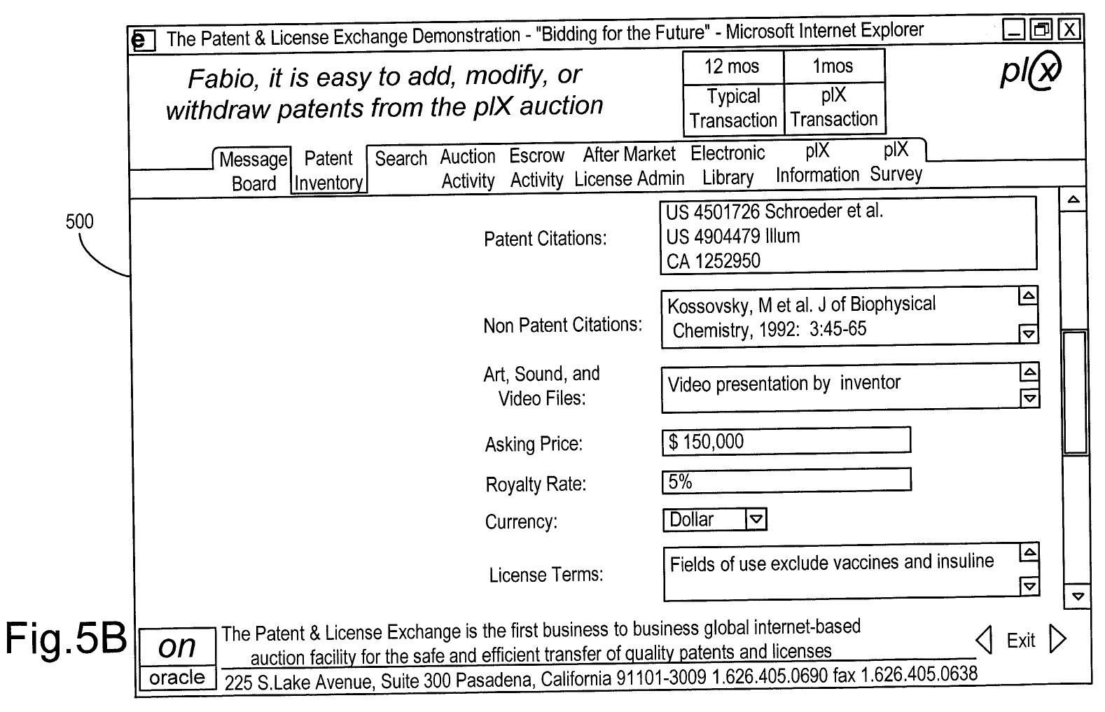

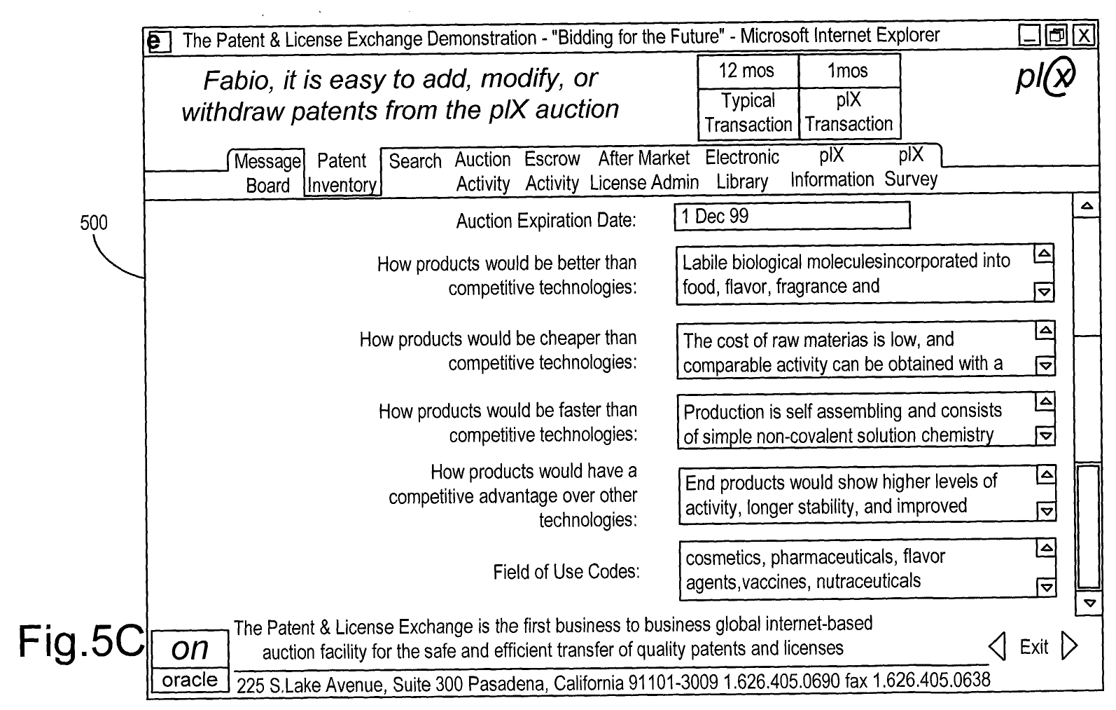

FIG. 3 is a flow diagram of an exchange operation 300, in accordance to an embodiment of the invention. First, in stage 310, a seller stores data describing the IP listed on the exchange in database exchange 270. A sample of the information stored by the seller in exchange database 270 is shown in FIGS. 5A-5C. FIGS. 5A-5C are partial views of patent information page 500 listing the information captured in exchange database 270 for a given patent listed on the exchange. The buyer can view the information shown in FIGS. 5A-5C by simply scrolling the contents of patent information page 500.

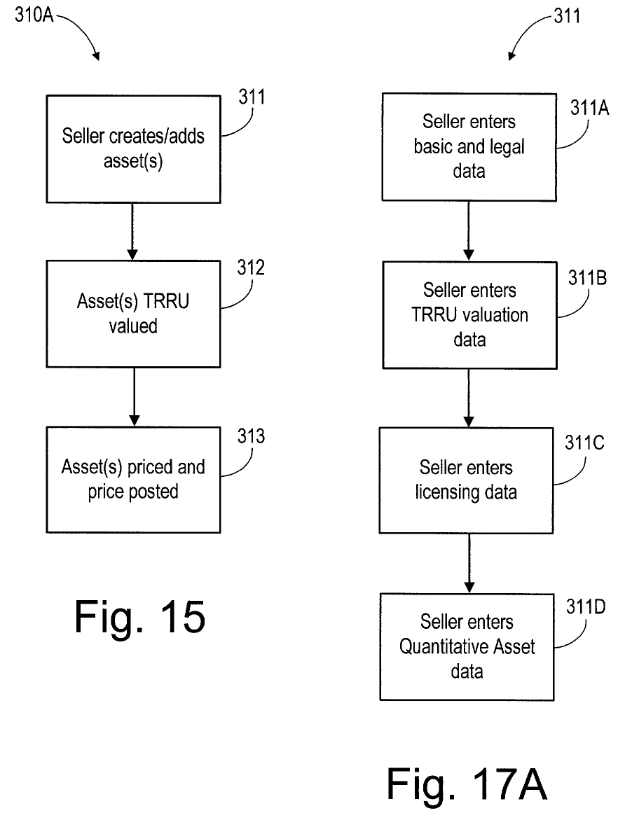

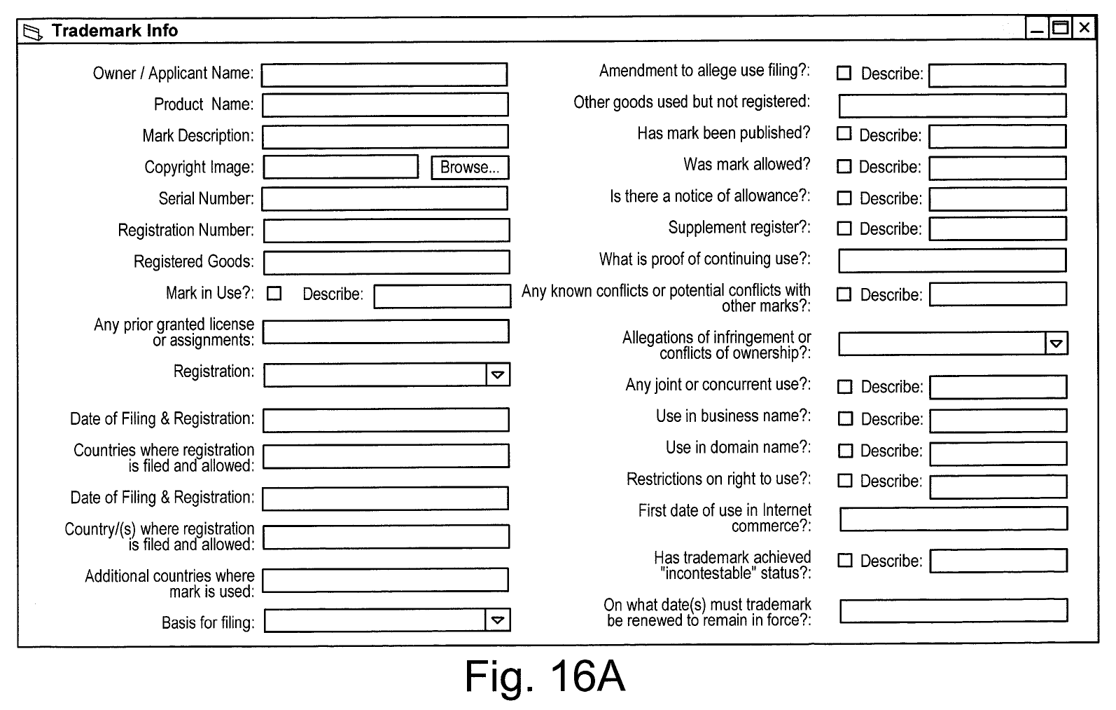

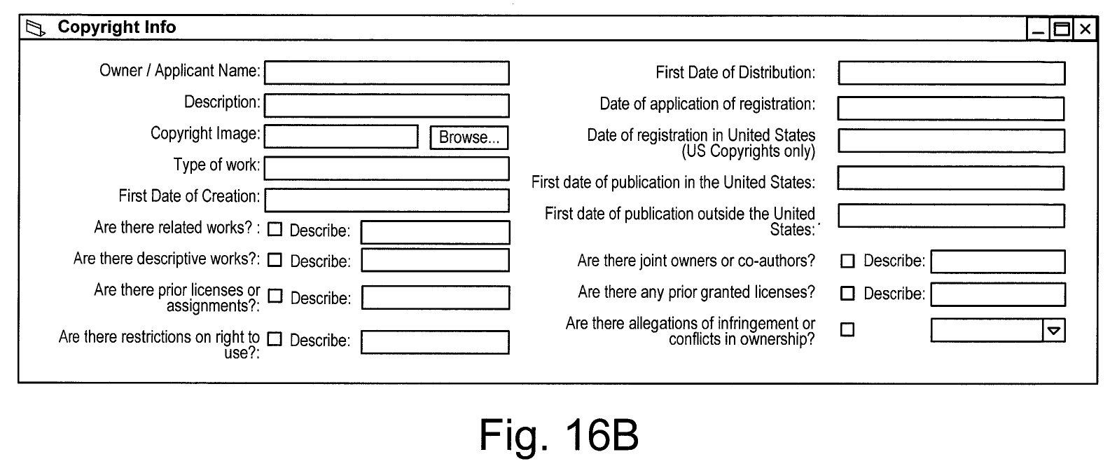

FIG. 15 is a flow diagram of stage 310A which is an alternative embodiment of stage 310, in which a seller stores data describing the IP listed on the exchange. In stage 310A, an IP asset offered for sale or license can consist of a single patent or multiple patents pertaining to the same technology. Additionally an IP asset can include pertinent trademarks or copyrights. In stage 311, the seller creates a portfolio for the first time or adds a patent, trademark, or copyright to an existing portfolio. The listing screens for entering trademark or copyright information are shown in FIGS. 16A and 16B, respectively. The discussion below assumes the IP portfolio includes at least one patent, and that one patent can be considered a central patent. Those skilled in the art will readily appreciate how the exchange operation is modified for IP assets that do not include a patent.

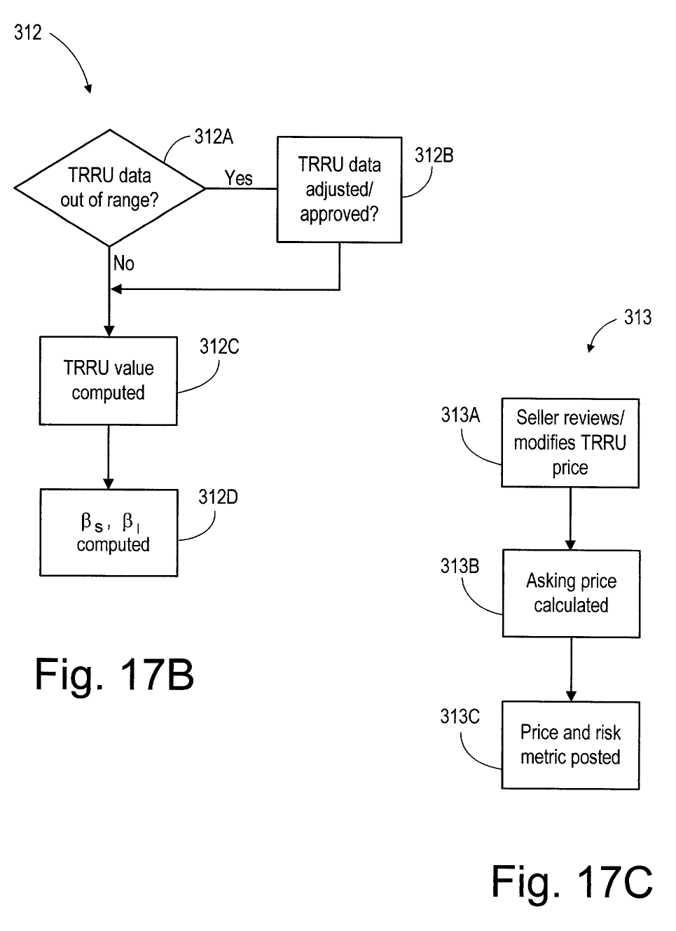

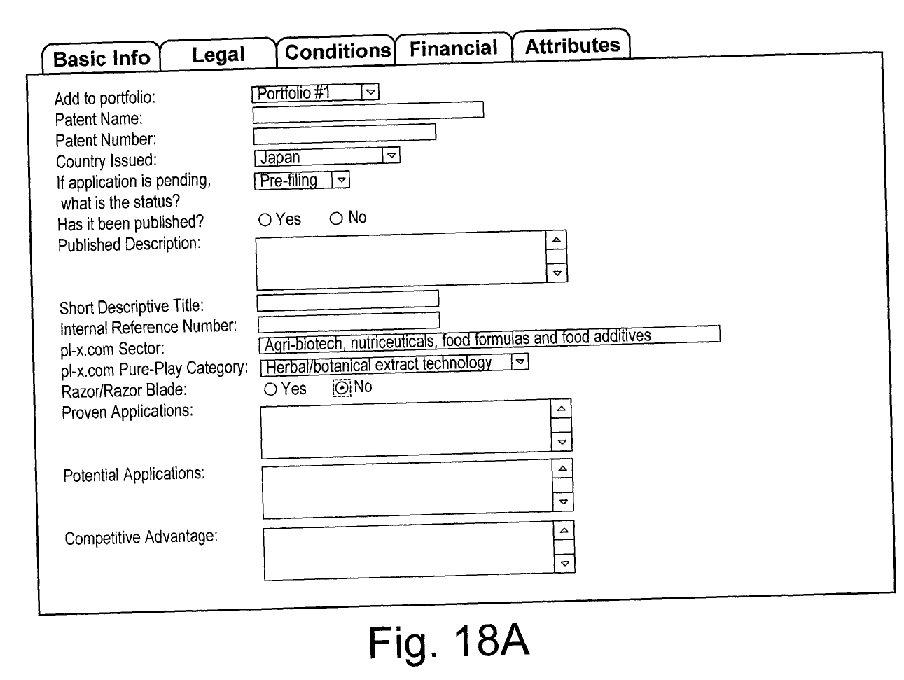

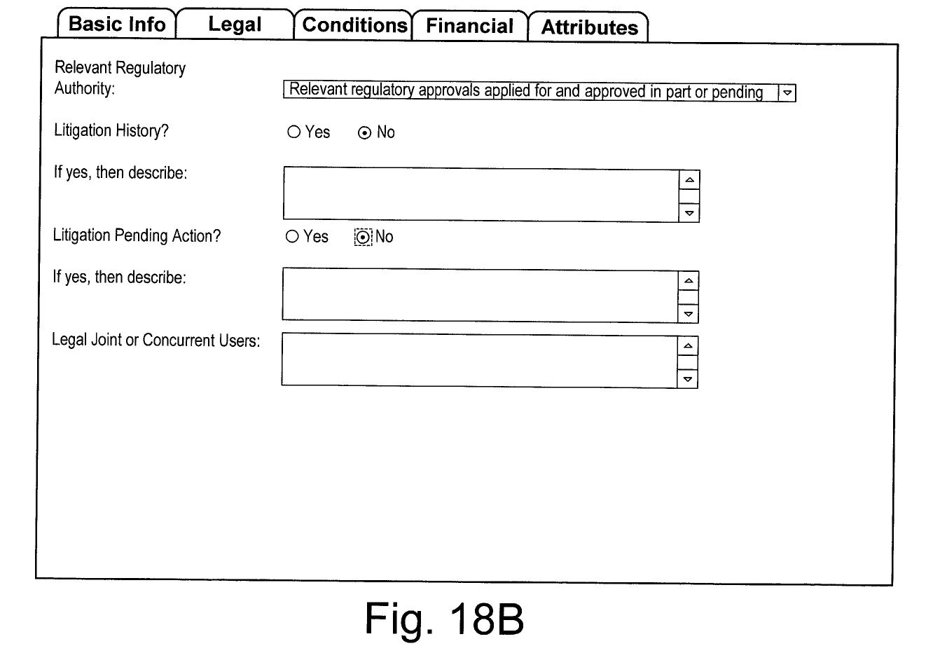

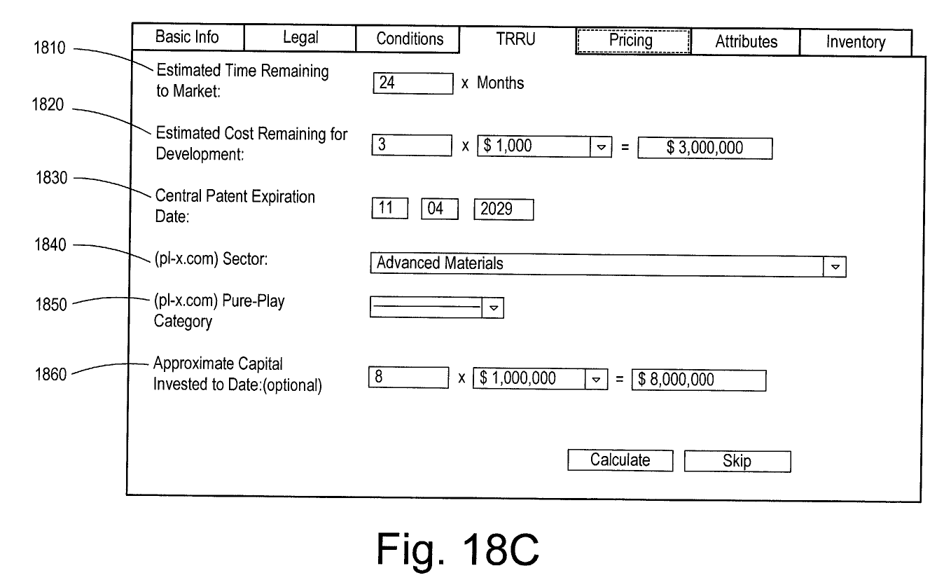

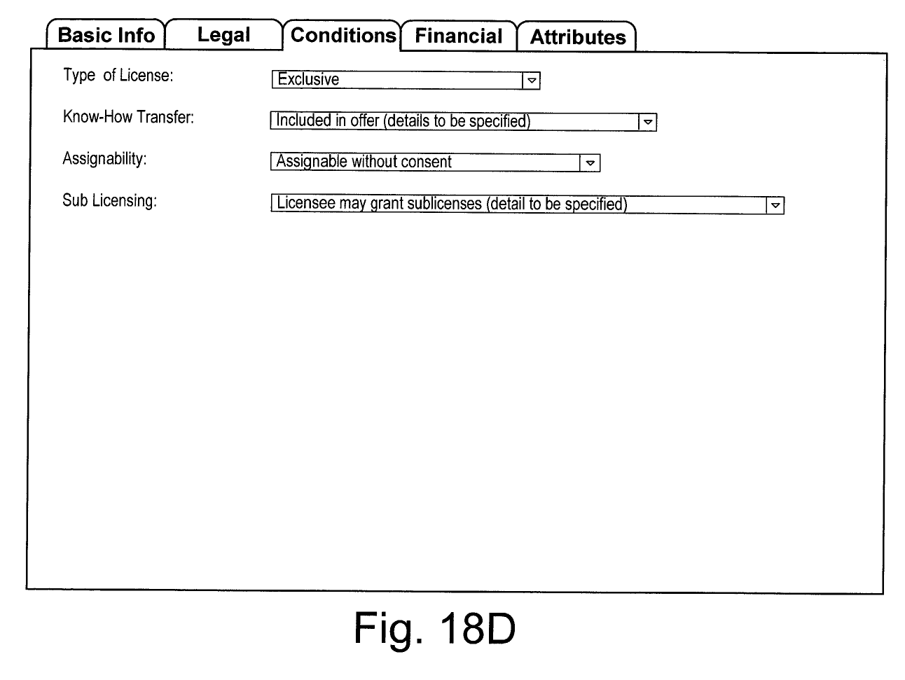

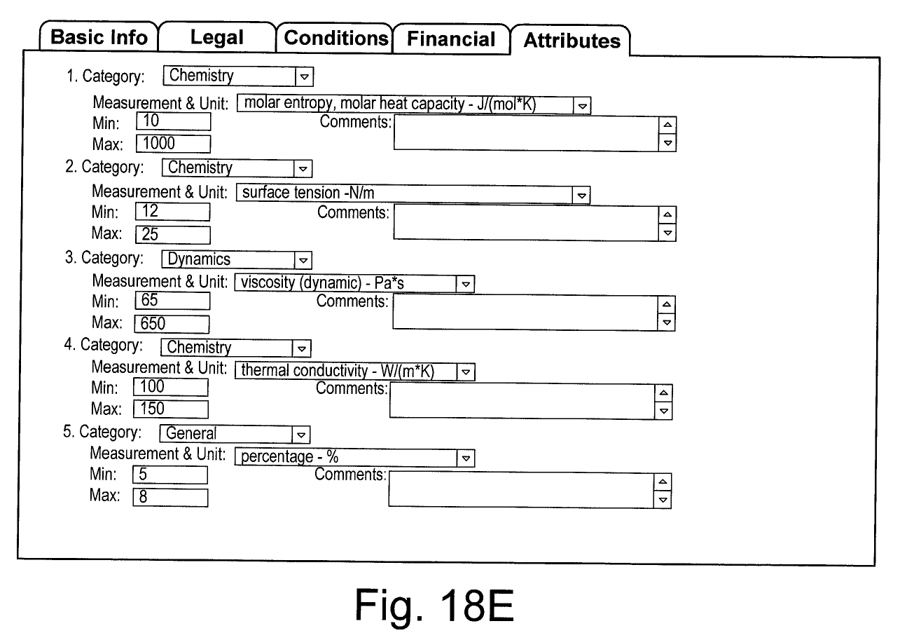

Stage 311 is shown in detail in FIG. 17A. In stage 311A, the seller stores basic and legal information about the IP asset, as illustrated, for example, in FIGS. 18A and 18B.

In stage 311B, the buyer enters financial information that will be used to calculate a suggested price using the TRRU valuation model, described below under Exchange Financial Operations. A sample input screen is illustrated in FIG. 18C. The TRRU valuation data includes five fields: (1) Estimated time until a product based on this technology can be launched, 1810; (2) Estimated cost remaining for product development, 1820; (3) Central patent expiration date, 1830; (4) Sector, 1840, and “pure play,” 1850, category; and (5) (Optional) Approximate capital invested to date, 1860.

The commercial sector and pure play category, narrowly focused market segment within the sector, are described in connection with the TRRU valuation model.

In stage 311C, the buyer enters data on licensing conditions including (1) field of use; (2) whether a license is exclusive; (3) maximum number of licenses, if any, if not exclusive; and (4) whether a license is assignable or can be sub-licensed. One example of licensing data input is illustrated in FIG. 18D.

In stage 311D, the seller enters a quantitative characterization of the technology which is stored in exchange database 270 in a Quantitative Asset Database. The Quantitative Asset Database provides a numerical record of the operational and competitively advantageous features of the technology. The fields of the Quantitative Asset Database are units in SI (Scientifique Internationale) units, a minimum value achieved by the technology, expressed in SI units, a maximum value achieved by the technology, expressed in SI units, and a comment field. For example, to describe a patent for a superconductor with 0.01-0.05% current loss at −30 to −10° C., the seller would enter “percentage” in the unit field, “0.01” in the minimum value field, “0.05” in the maximum value field, and “current loss” in the description field. A second category would describe the temperature range. Another example of the fields of the Quantitative Asset Database is illustrated in FIG. 18E. The Quantitative Asset Database provides an additional tool to buyers in searching exchange database 270, in stage 320, discussed below, beyond natural language searching.

For the convenience of sellers and buyers, in some embodiments a Translator is associated with the Quantitative Asset Database. The Translator converts values expressed in commonly used units to the SI units for that quantity. Thus, in entering information into the Quantitative Asset Database, sellers can express the attributes of their technologies in whatever units are customarily used commercially. The quantitative values are stored in the Database in SI units; however, the seller's units are preserved and are used in displaying the asset details. Similarly, buyers can search the database by specifying the units of their choice. In one implementation of the search process, the Translator converts attributes expressed in units used by the buyer to SI units, conducts the search in SI units, and converts the search results back to the units used by the buyer for the display of results to the buyer. The remaining stages of stage 310A in which asset(s) are TRRU valued (stage 312) and asset(s) are priced and prices are posted (stage 313) are described below.

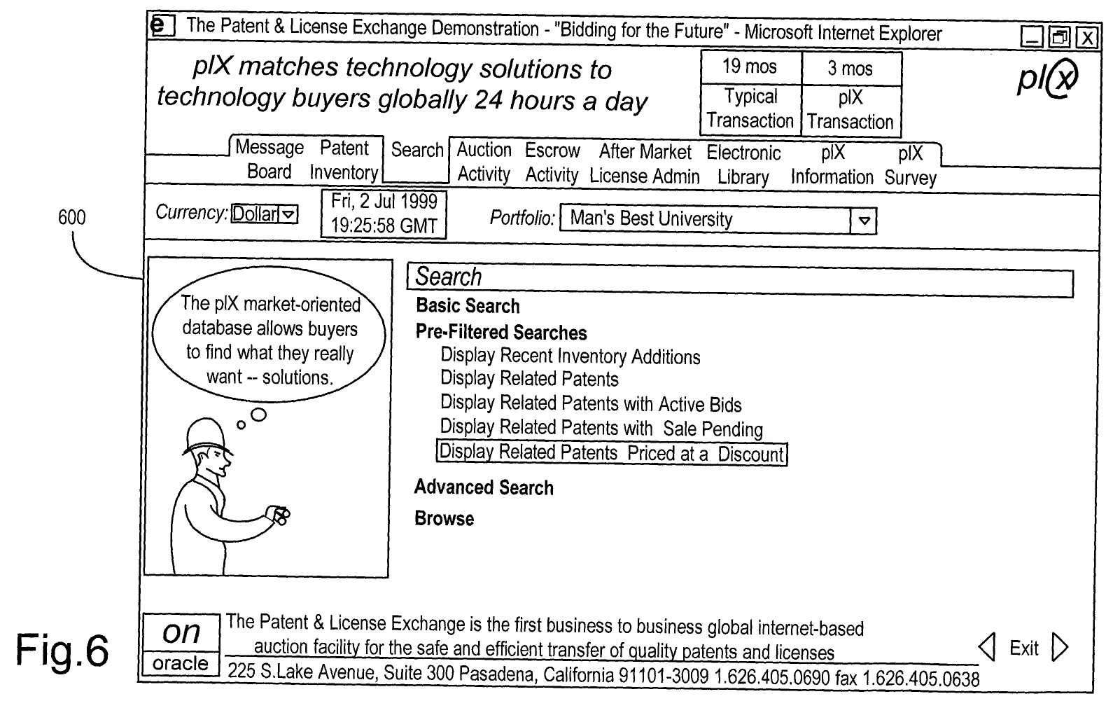

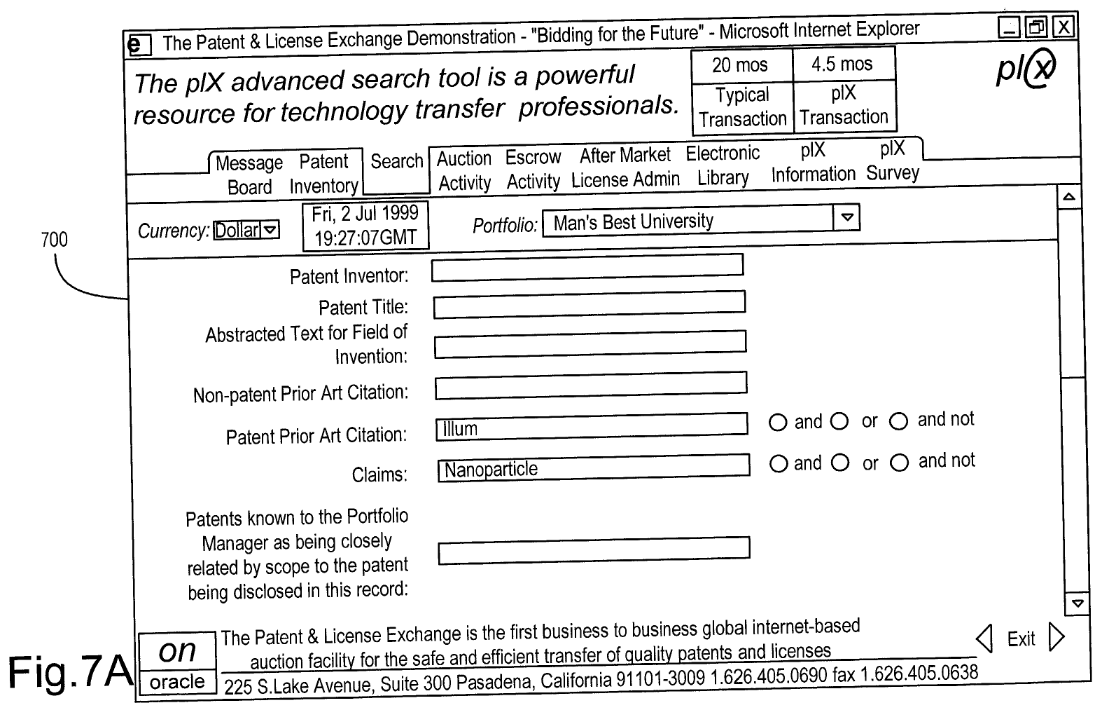

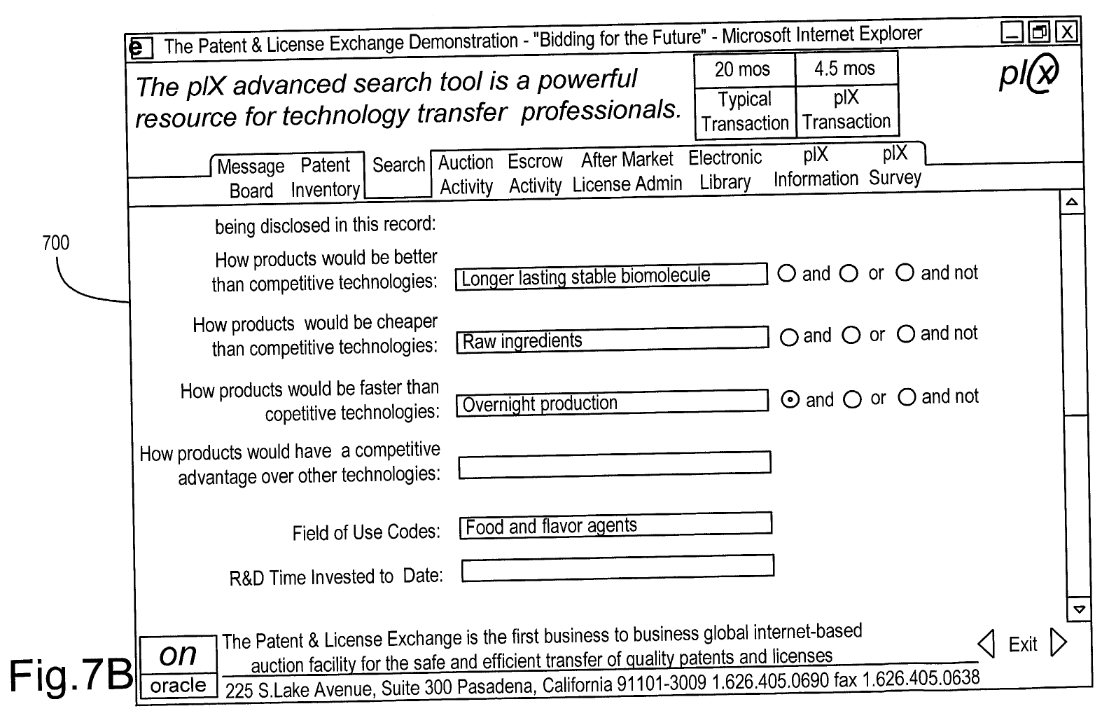

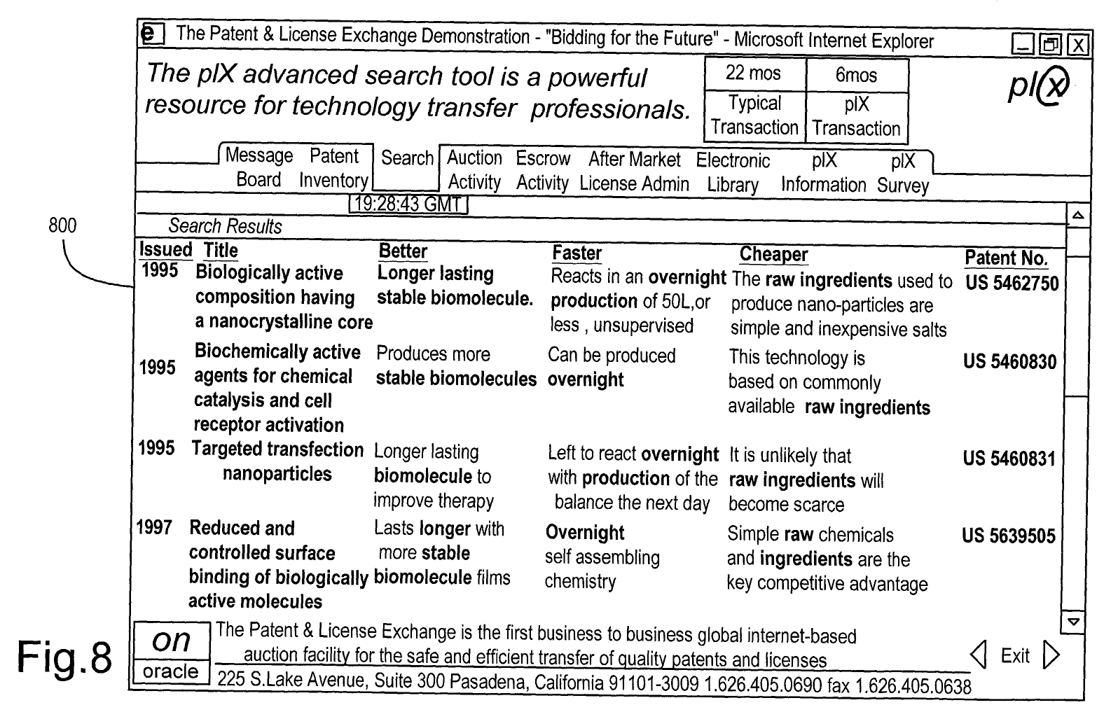

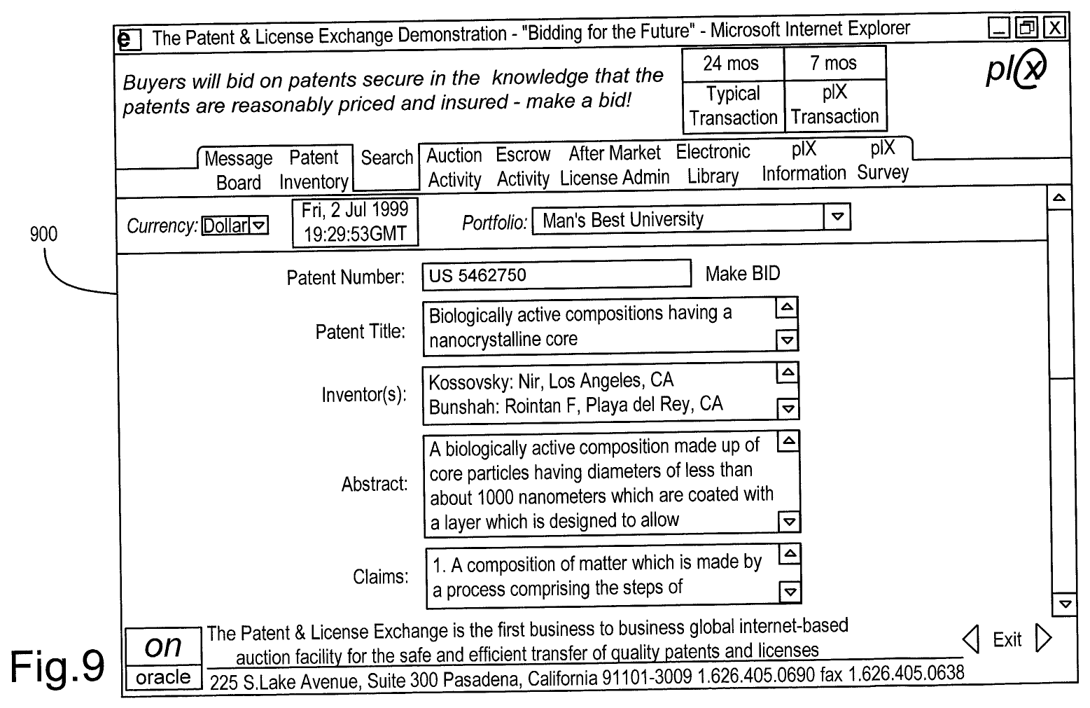

Returning to the flow of FIG. 3, a potential buyer can then retrieve the information stored by the seller in exchange database 270 by searching exchange database 270 in stage 320. A search menu page 600 is shown in FIG. 6, while partial views of a search page 700 are shown in FIGS. 7A and 7B. The buyer is able to select among several search options on search menu page 600. The buyer can then enter search criteria on search page 700. The buyer can view the information shown in FIGS. 7A and 7B by simply scrolling the contents of search page 700. The results of the search are shown in search results page 800 (FIG. 8). The buyer can view the information stored in exchange database 270 for each of the patents returned by the search by simply clicking on a corresponding link on search results page 800. This information is displayed in results information page 900 (FIG. 9).

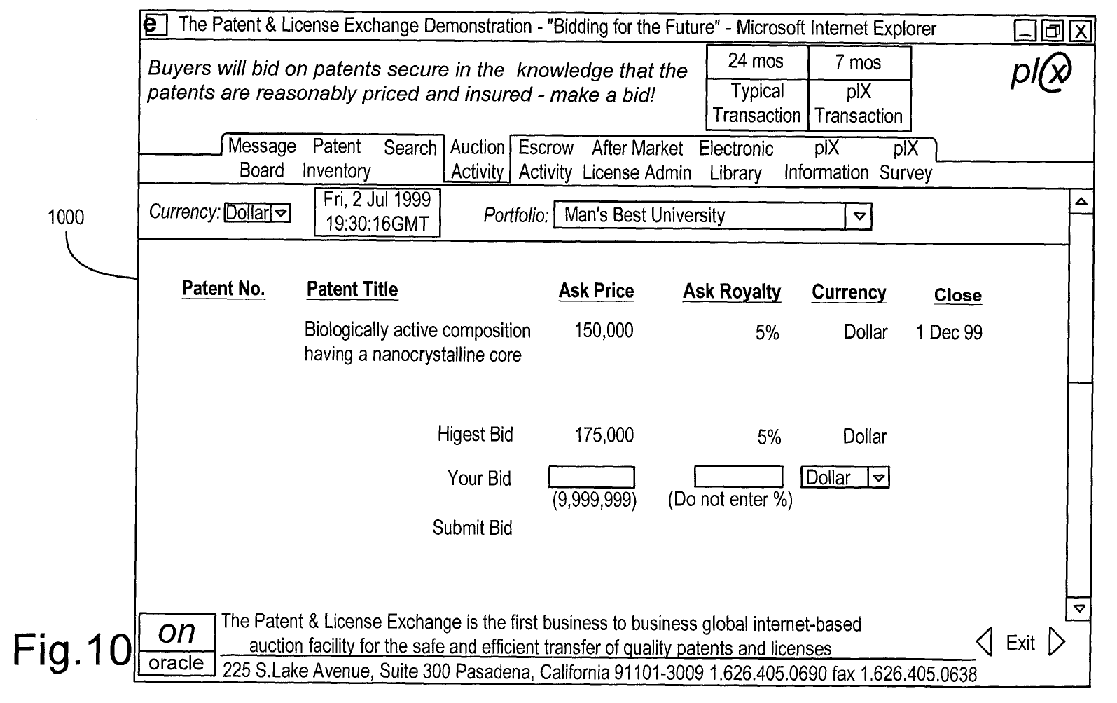

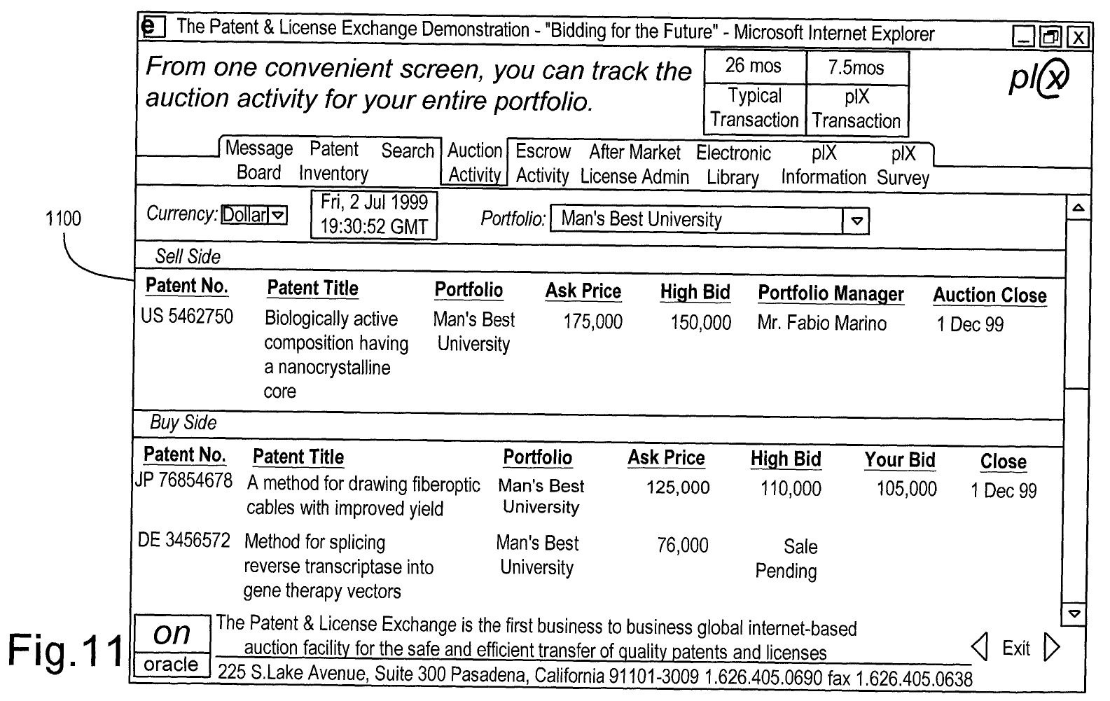

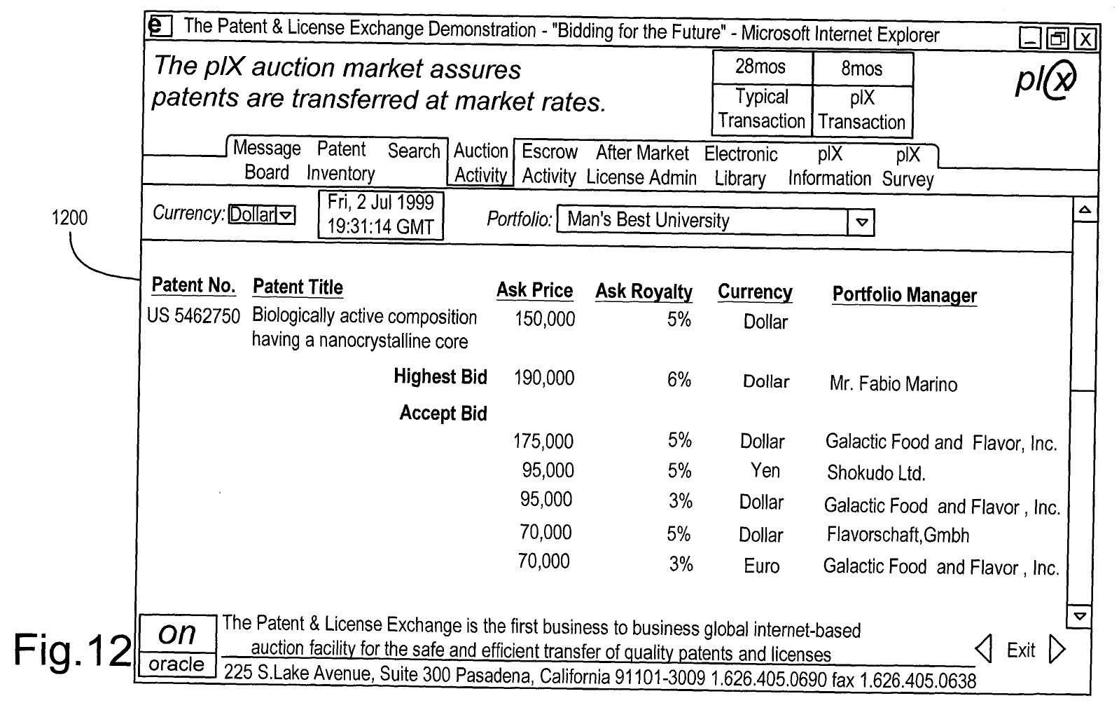

If the buyer decides to submit a bid on one of the patents listed on the exchange, the buyer can then submit a bid by entering the bid's terms on bid page 1000 (FIG. 10). The bid is received by computer system 100 in stage 330 and transmitted to the seller in stage 340. FIG. 11 illustrates an auction status page 1100 used to notify buyers and sellers on the status of current bids. As shown in FIG. 11, each market participant can act as both a seller and a buyer. The seller can then obtain more detailed information about each bid submitted for the patent by clicking on a corresponding link on auction status page 1100, causing bid detail page 1200 (FIG. 12) to be displayed.

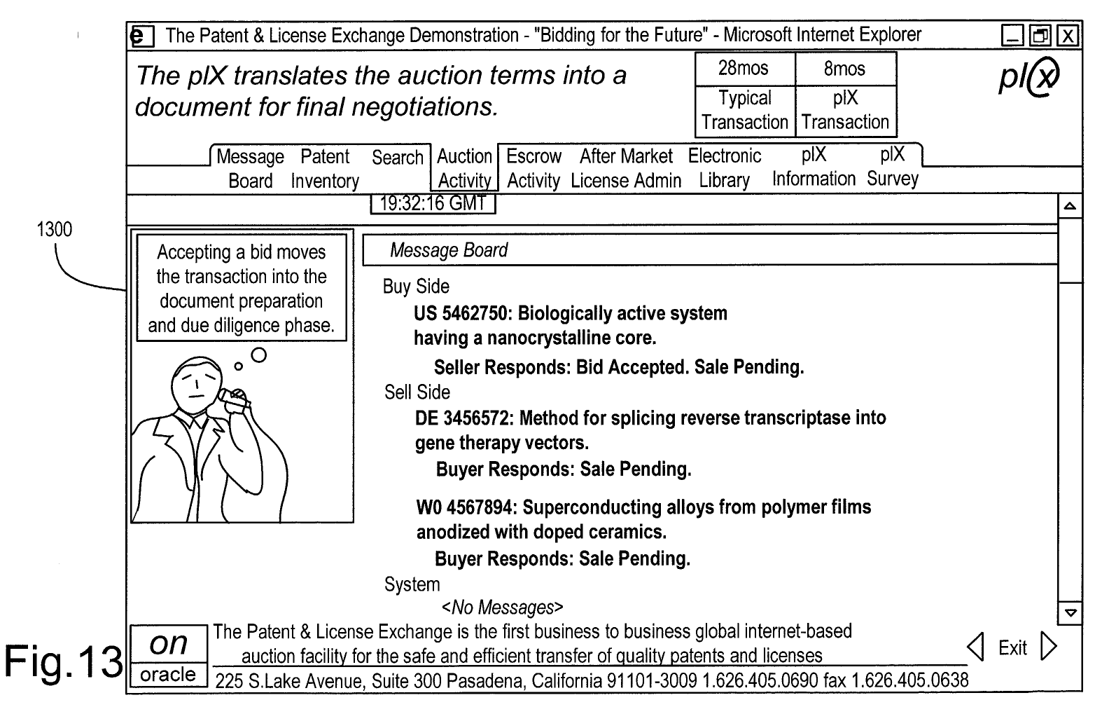

Once the seller has received a satisfactory bid, the seller can accept the bid by selecting a corresponding link on bid detail page 1200. The bid acceptance is received by computer system 100 in stage 350. The buyer is then notified of the acceptance of the bid and the patent is transferred to the buyer in stage 360, a contract finalization and fulfillment stage during which due diligence is conducted and insurance and escrow services are provided. FIG. 13 illustrates a message board page 1300 used to communicate the acceptance of the bid and other closing related information to sellers and buyers. Once the transfer of the IP rights listed on the exchange has been completed, operation 300 terminates.

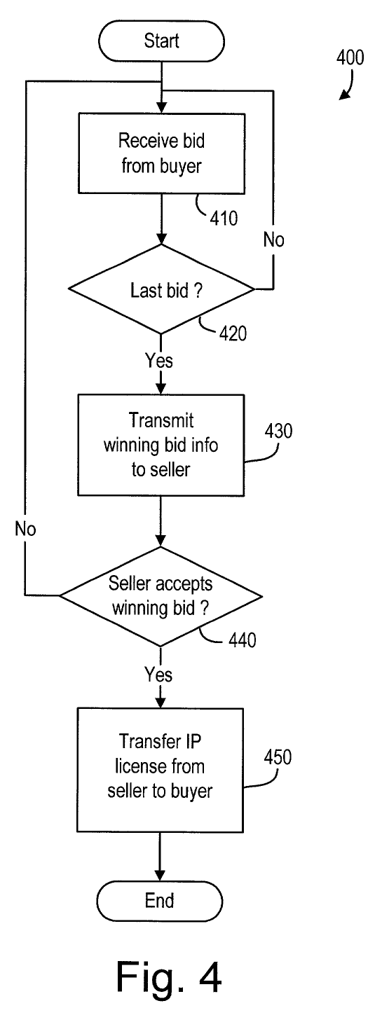

FIG. 4 is a flow diagram illustrating an auction, also known as a price discovery operation 400, in accordance to an embodiment of the invention. Auction operation 400 is similar to exchange operation 300, except that multiple bids may be entertained by the seller in stages 410 and 420. Once computer system 100 has determined that, in accordance to (seller-controlled) predefined auction rules, the last offer has been received, the selected bid is transmitted to the seller in stage 430. Stage 440 then determines whether the seller has accepted the selected bid, in which case the IP rights are transferred from the seller to the buyer in stage 450, a contract finalization and fulfillment stage during which due diligence is conducted and insurance and escrow services are provided. Otherwise, stages 410-440 are repeated until either the seller either accepts a bid or withdraws the lot from the auction.

The exchange website (pl-x.com) supports three separate markets: a patent asset market, an asset options market, and a securitized asset cash flows market.

### The Patent Asset Market

The patent asset market is an electronically-operated forum for buying and selling IP rights. A corporation in need of new products for its product pipeline shops the market, brushing over technologies that are not of interest, while, after conducting commercially reasonable evaluation, placing bids on those that are. To facilitate this, the exchange provides a user-friendly graphic interface, a comprehensive listing of available technologies, an intuitively easy way to search the listing to find those of interest, a suggested whole asset valuation, a measure of financial risk, and a suggested selling price for each technology offered. The actual price, agreed upon or “discovered” by buyer and seller in the markets, will be independent of either the whole asset value or the suggested license price. In the interest of expediting transactions, the exchange provides a suggested price and measure of financial risk, denoted by β.

### The Asset Options Market

Calls and puts on the exchange auction market enable buyers, sellers and long term holders to hedge their-IP interests. Similar to the asset market, the options market is an electronically-operated forum for buying and selling IP rights. The specific rights are options to technology which are sold concurrently with an option exercise price that reflects the costs of converting the option into a full license or patent sale. Similar to the asset market, the exchange provides a user-friendly graphic interface, a comprehensive listing of available technology options, an intuitively easy way to search the listings to find those of interest, and a suggested selling price for each option offered. It is conceivable that a single IP asset could be offered simultaneously as a license and as an option. The exchange electronically monitors the factors affecting pricing continuously so that the recommended asset and option prices are rationally related.

### The Securitized Asset Cash Flows Market

This market enables trading in grouped IP assets. The groupings and valuations are modeled on Real Estate Investment Trusts (REIT's).

### Market Participants—Qualified Licensing Agents

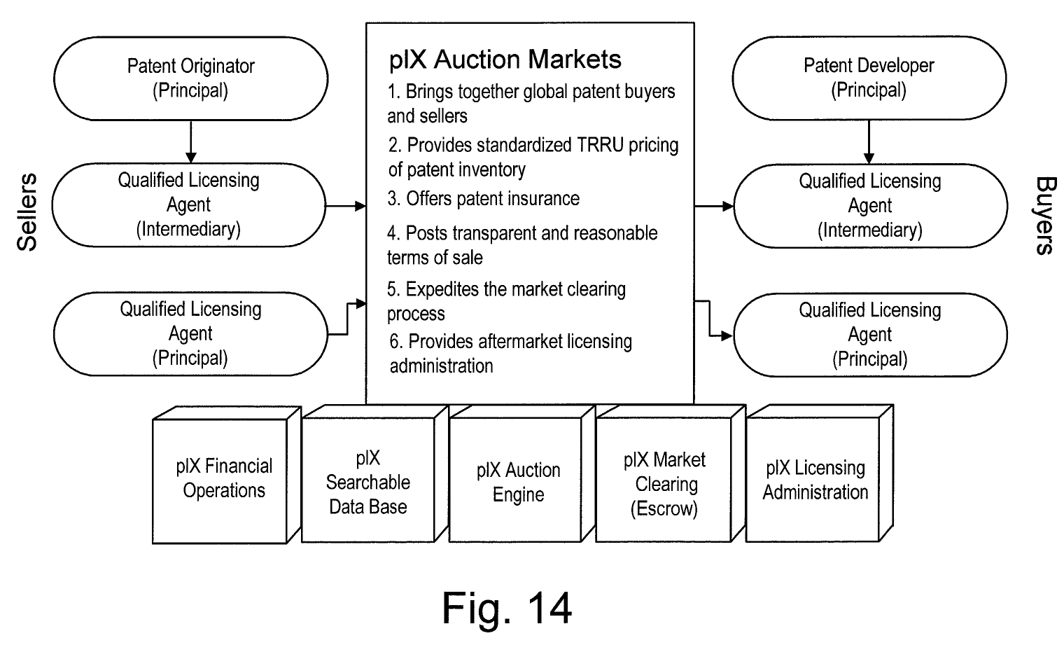

The computer system of the present invention provides an ideal IP rights exchange for high integrity participating global buyers and sellers. These participants, known as Qualified Licensing Agents (“QLAs”), must meet certain quality standards as shown in the Table 1 below. Principal QLAs are originators or owners of IP assets or buyers and users of IP assets. Intermediary QLAs are agents acting on behalf of a principal buyer or seller. Government entities, universities and businesses not meeting the exchange's participation criteria or not wishing to participate directly, may buy or sell IP rights through intermediary QLAs, as shown in FIG. 14.

TABLE 1

| | TRANSACTIONAL | STANDING |
|---|---|---|
| QLA | QUALIFICATIONS | QUALIFICATIONS |
| Government | Applied for a | An affiliate of an |
| | minimum of ten | official State, |
| | patents per year | Federal, United |
| | in each of the | Nations, European |
| | immediately | Union or Asian |
| | preceding three | government agency. |
| | calendar years. | |
| University | Applied for a | A college or |
| | minimum of five | university with |
| | patents per year | state, national |
| | in each of the | government or |
| | immediately | national |
| | preceding three | educational |
| | calendar years or | association |
| | maintains an | accreditation. |
| | inventory of at | |
| | least ten | |
| | unlicensed or | |
| | otherwise | |
| | available patents. | |
| Business | Applied for a | An entity for |
| Entity | minimum of five | which at least one |
| | patents per year | class of security, |
| | ineachof the | of it or an |
| | immediately | affiliate lists on |
| | preceding three | one of the world's |
| | calendar years or | top three |
| | maintains an | exchanges: New |
| | inventory of at | York, London or |
| | least ten | Tokyo, or is a |
| | unlicensed or | company listed on |
| | otherwise | the Financial |
| | available patents. | Times' World Stock |
| | | Markets pages |
| | | (selected on the |
| | | basis of company |
| | | capitalization), |
| | | or is listed on a |
| | | national exchange |
| | | certified by the |
| | | California |
| | | Commissioner of |
| | | Corporations under |
| | | Section 25101 (a) |
| | | of the California |
| | | Corporations Code. |
| Law Firm | The firm must, in | Each attorney |
| | the aggregate, | participating |
| (Intermedi | close licenses | through the |
| ary acting | and/or sales of at | particular firm |
| on behalf | least ten patents | must be in good |
| of a | per year. | standing with at |
| patent | | least one state |
| buyer or | | bar or comparable |
| seller) | | national |
| | | regulatory |
| | | authority with a |
| | | supervising |
| | | partner who is a |
| | | member in good |
| | | standing of the |
| | | patent bar. |
| Other | Capitalization | Three letters of |
| | requirement and | recommendation |
| | bond, terms | from current |
| | pending. | exchange qualified |
| | | licensing agents |
| | | who are in good |
| | | standing. |

### Overview of Auction Process

The auction markets offer a personalized, inviting and friendly environment. A brief description of the market process and the business experience follows. Details of auction operations are provided below.

### Exchange Auction Access

The Exchange services two types of participants—QLAs and niche participants. The QLA, whether an 10 attorney or licensing executive, has unlimited access to the site for listing, inventory searches and bidding. The niche participant has access to different elements of the site depending on the terms of the agreement with the exchange. For example, Inventors are a niche participant. On the markets of the Exchange, Inventors have the opportunity to offer patented, copyrighted, or trademarked intellectual property for license or sale. However, unlike QLA's Inventors do not have the right to purchase or license and inventors are not offered certain insurances, such as Royalty Insurance, that are available under certain conditions to QLA's.

### Auction Flow

The exchange offers an intuitive, easy and fun IP assets search and bid experience.

Searching for Patents

A powerful search engine lets participants search for particular items on the site. They are able to run queries from exact matches to “and/or” scenarios using a combination of natural language and logic searches. The latter searches can utilize the Quantitative Asset Database.

Navigating the Site

An intuitive and elegant menu-driven Web browser makes navigating the site and completing listing, search and bid forms easy. A context sensitive help facility supports all software functions.

Exploring Inventory

A sophisticated bidder interface reviews online product information including detailed product descriptions and images (graphs, charts, and photos), as well as real-time bid information. This interface provides optimal participation and ease of use.

### Scheduling Special Auction Events

One of the crucial success factors for the exchange market is to bring the maximum number of buyers interested in specific IP assets to the opening of special auction events for selected IP assets in inventory. A simple means of achieving this goal is to set up a regular auction schedule and publicize in advance so that QLAs can set aside time to participate in the auction.

### Exchange Financial Operation

### Independent Valuation to Expedite Pricing

Every patent listed on pl-x.com will receive a valuation based on the TRRU valuation model. The actual license price, agreed upon by buyer and seller in the pl-x.com market, is independent of the pl-x.com suggested valuation and the seller's suggested price and is discovered through market mechanisms. The TRRU valuation and the suggested price are provided by the pl-x.com exchange as a service to both buyers and sellers to help expedite valuation and negotiations. The seller can chose whether to use the TRRU value as their asking price, as their secret floor, or as a point of reference for their own valuation process. The TRRU value is designed to give owners a “reality check,” so they don't price a patent out of the market—or undervalue their intellectual property and to give buyers confidence that the asking price is reasonable. The TRRU valuation also assists pl-x.com in determining the amount of insurance coverage to be provided and the commission due.

### TRRU Valuation Model

The TRRU valuation model combines real options theory with data from publicly-traded, technology-rich companies to compute reasonable market values for intellectual property that aid buyers and sellers to converge on a fair market value. The valuation model is grounded on the concept that a patent behaves financially as if it were a call option on a future technology asset. A patent, like a call option, is a right to an asset that may or may not have future value.

The Black-Scholes option pricing formula for call options on stock has become widely accepted. According to the formula, the value of a stock call option C depends on the option strike or exercise price, X, the price of the underlying stock, S, the time until the option must be exercised, τ, the variance of the stock price, σ², and the risk free rate of return r, as

C=SN(d₁)−Xe^{-rτ}N(d₁−σ\sqrt{τ}) (1)

where

$${d}_{1} = \{ ln ( \frac{S}{X} ) + r τ + \frac{{σ}^{2} τ}{2} \} / σ \sqrt{τ} \qquad ( 2 )$$

and the function N(d) is the standard normal cumulative distribution function used in statistical theory.

In the TRRU valuation model, an adaptation of the Black Scholes formula is applied to compute the value of intellectual property using measurable features of the patent or patents on offer, or of values of comparable technologies, in place of the values used for call options on stock. In place of the strike price, X, the amount of money that must be spent by the owner of a call option in order to receive the underlying stock, the TRRU valuation model uses the remaining product development cost, which is the amount of money that must be spent by the owner of a patent in order to turn the raw technology into a commercial product. The time variable, τ, is interpreted as time until launch, that is, the time it would likely take a well-funded corporate entity to turn the patent in its present state of development into a product ready for launch. For the risk free rate of return, r, which has the conventional meaning, the offered rate on 90-day U.S. government treasury bills is used.

The conceptual analogy to the price of the underlying stock, S, for valuing intellectual property is the value of the underlying technology if it were a finished product. In place of the stock price, S, the TRRU model uses a proxy value based on the mean enterprise value per product at launch, M_{CAT}, of small, publicly-traded companies with products in the same technology niche as the intellectual property being valued.

The exchange has defined a set of major commercial sectors which are expected to span the technologies listed on pl-x.com. A suitable list of technology sectors is provided in Table 2.

TABLE 2
Technology Sectors

| Sector | |
|---|---|
| No. | Sector Name |
| 1 | Advanced materials |
| 2 | Information technology |
| 3 | Automotive technology |
| 4 | Express package transport and |
| | logistics |
| 5 | Health technology |
| 6 | Aerospace and defense |
| 7 | Agri-biotech, nutriceuticals, food |
| | formulas, and food additives |
| 8 | Food processing and harvesting |
| | technology |
| 9 | Rail, water transport, and trucking |
| | technology |
| 10 | Firearms, explosives, and lasers |
| 11 | Commerce logistics, including |
| | financial instrument technology |
| 12 | Telecommunications |
| 13 | Consumer entertainment devices |
| 14 | Consumer household products |
| 15 | Basic materials and natural energy |
| | procurement |
| 16 | Storage and environmental |
| | preservation technology |
| 17 | Apparel |
| 18 | Building structure, manufacturing |
| | equipment, and civil infrastructure |
| | technology |
| 19 | Software |

Each major sector, in turn, includes multiple “pure play” categories, which are narrowly focused market segments within the major sector. For example, the information technology sector includes the pure play categories of digital video processing, remote control technology, network/communication security, digital memory devices, and programmable logic devices, to name just a few. For each pure play category, a suitable number, for example, from about 3 to 30 pure play companies, whose value is entirely tied up in a single product or small number of products within the pure play category have been identified. The suitability of each pure play company is monitored regularly by the pl-x.com financial operations staff, and additions or deletions are made to each category when companies become diversified, get acquired, or cease developing a product.

The parameter McAT used in the TRRU valuation calculation is determined from the enterprise value of the pure play companies in the same pure play category as the IP asset being valued. Enterprise value, EV, is the market capitalization, defined as the number of shares outstanding times the share price, minus the book value, defined as the total assets less total debt of the company. The mean technology value per product at launch for each company, M_{cpny} is given by the enterprise value divided by the number of products, NP, and modified by the mean of the time until launch of the NP products, MTL, according to the formula

M_{cpny}=(EV/NP)(1+Δ)^{MTL} (3)

The discount rate, Δ, defined as

Δ=0.1+Wσ² (4)

has a minimum of 0.1 or a 10% interest rate. W is a weighting coefficient determined by exchange financial analysts. The value of W is refined over time from comparison of actual closing prices for intellectual property deals with computed TRRU model prices. The variance, σ², is defined below. For technologies generally considered to be risky, such as biotechnology, typical discount rates are between 0.3 and 0.5.

The factor (1+Δ)^{MTL} increases the enterprise value to what it would be when the product(s) are introduced since the stock price takes into account the fact that the company has not yet launched its products. If the company has already launched all of its products, MTL=0, then M_{cpny}=(EV/NP). The mean technology value at launch for the pure play category, M_{CAT} is given as the average over the M_{CPNY} values for the 3-30 pure play companies in the category.

The last variable, σ², is taken as the average of the variances about the mean of the natural logarithm of stock price returns of the companies used to calculate M_{CAT}. The variance σ² provides a measure of the variability of similar technologies. To determine the value to use for S, the underlying value of a technology that has not yet been commercialized, the mean enterprise value, M_{CAT}, which refers to a product at launch, is discounted according to the time until launch, τ. The technology value, S, may be calculated as

S=M_{CAT}/(1+Δ)^{τ} (5)

where Δ is the discount rate of Eq. (4).

The stock prices on which M_{CAT} and σ² are based fluctuate on a minute-by-minute basis. The prices are downloaded periodically from financial market data providers to exchange database 270 in FIG. 2B and the values M_{CAT} and σ² are recalculated with updated data. In one implementation, closing stock prices are downloaded at the end of each business day. Alternatively, downloading and updating of values is performed at periodic intervals throughout the business day.

Finally, the TRRU valuation model modifies the computed value of the intellectual property to take into account the remaining patent term of the central patent of the IP asset being offered. An implementation of the model uses the formula

TRRU=C(YE/17)WE (6)

where TRRU is the suggested price, C is computed from formula (1) using the definitions above, Y_{E} is the number of years until expiration of the patent, 17 years is assumed to be an average patent life, and WE is a weighting coefficient determined by the exchange analysts from experience.

### Price Calculation Method

The TRRU valuation model provides a suggested value for the total intellectual property asset. The TRRU value for the total asset can be modified by the seller, as described below in the detailed process flow discussion. The asking price for a particular transaction can also be modified by considerations such as field of use, exclusive or non-exclusive license, and whether the patent is assignable. In addition, the price can be composed of different components, a fee paid by the buyer initially and future obligations. The exchange includes a method of considering all these factors in calculating an asking price.

A suggested asking price TASK is computed from the TRRU model value, with optional seller modification, by the formula

TASK=(TRRU*F/NL)*((1+CP)/2)*((1+Δ)/2) (7)

where F is a fraction of the total market to which a license will be granted. The total market can be defined, for example, in terms of field of use or of geographical regions. The asking price is reduced by the number of licenses NL to be granted. The logical variable CP=1 if there is a cap on the number of licenses and CP=0 if the number is unlimited. If an exclusive license is offered, NL=1, and CP=1 so the asking price is unmodified due to the number of licenses. The logical variable A is defined as 1 if the licensee will be allowed to sublicense (asset is assignable) and 0 if the asset is not assignable. The effect of the formula is to reduce the asking price of the asset if it is not assignable.

The suggested asking price TASK can be composed of four payment components: an upfront fee, royalty rate, guaranteed yearly minimum payments, and milestone payments. The upfront fee is the amount the licensee or buyer will pay the seller on the day the deal closes. The royalty rate is the percentage of the licensee's or buyer's sales of the product that will be paid to the seller. Guaranteed yearly minimum payments are the minimum royalty owed to the seller for each of the remaining years of the key patent of the intellectual property asset, as long as an “out clause” specifying terms on which a contract is broken, is not reached. Milestone payments are payments linked to specific events, such as achieving a certain state of product development or revenue level.

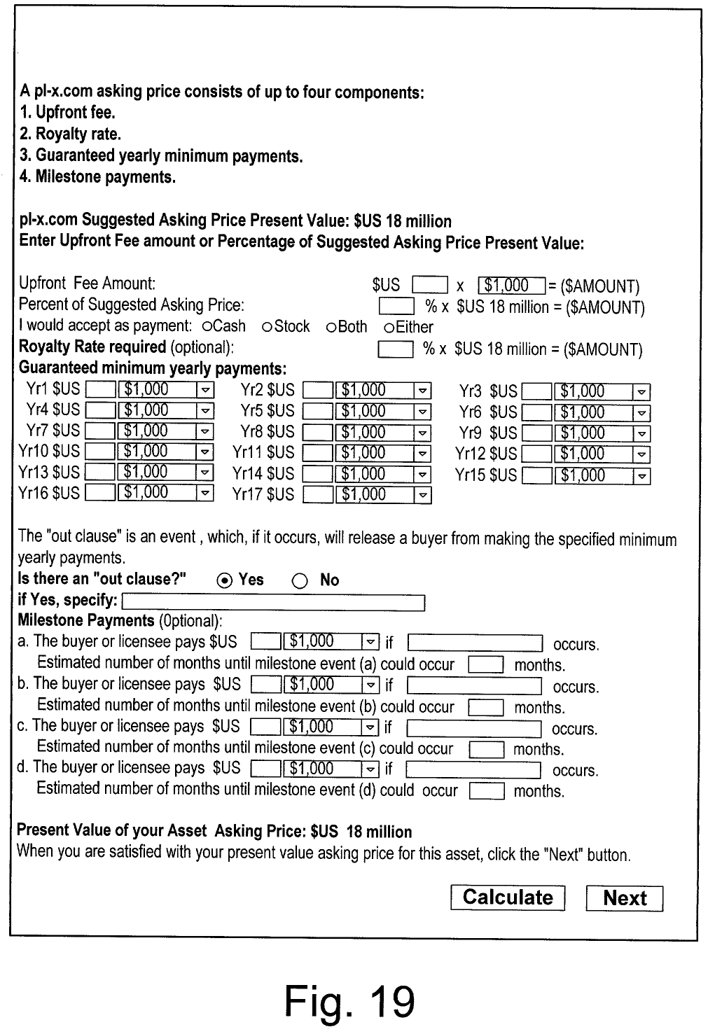

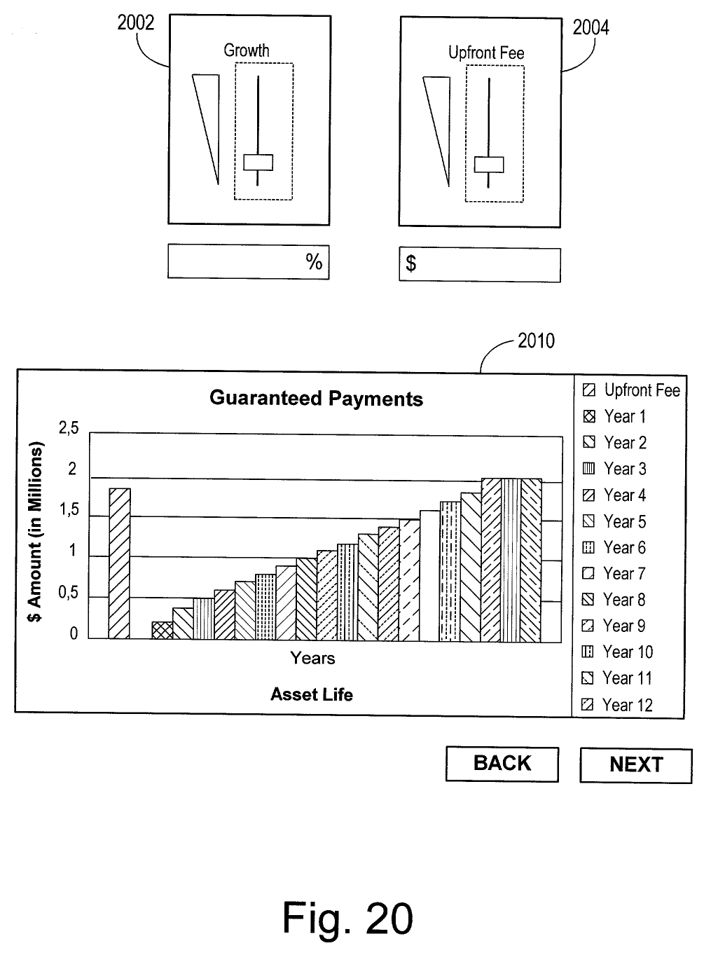

The suggested asking price can be allocated among the four payment components in any proportion. In summing the four payment components, guaranteed minimum annual payments are discounted to the present by the factor (1.0/(1+D))ⁱ where D is the discount rate used in the TRRU model valuation, and i is the number of years in the future. A sample of a web page used by the seller in allocating the asking price among payment components is shown in FIG. 19. In one embodiment, the exchange includes a method of enabling the seller to graphically visualize the effect on yearly cash flow over the life of the asset of different allocation schemes. For example, as shown in FIG. 20, a seller can observe a graph of payments over the asset life, 2010, change, as the growth in guaranteed minimum annual payments, 2002, and upfront fee, 2004 are adjusted.

### Intangible Asset Market Index

The exchange may also include indices of enterprise value, termed collectively Intangible Asset Market Index (IAM Index). A separate index may be constructed for each market sector defined in Table 2. The IAM Index can serve as a benchmark of raw technology value in various market sectors, allows for quantitative risk measurement, and can even act as a leading indicator for shifts in stock prices in large, technology-rich companies, due to the technology component of their total value.

The IAM Index for each sector is the average of the enterprise value, EV, for a number of small, technology-rich, non-service businesses heavily dependent on intellectual property, within that sector. The companies have minimal revenues and/or earnings and minimal infrastructure. Therefore, the enterprise value of these companies is a relatively pure measure of the value the market is assigning to the company's technology, that is, its intellectual property. Approximately 20 to 40 companies are used for each index. The companies that make up the IAM indices are not necessarily as tightly focused in a single technology as the “pure play” companies whose enterprise value is used in the TRRU valuation model. However, some pure play companies also may be used in the IAM Index.

### TRRU Risk Metric

One use of the IAM index is to allow buyers and sellers of intellectual property to assess the risk of the assets they are buying or licensing. In assessing conventional stocks, securities analysts frequently use a parameter termed beta, the relative fluctuation of the stock price in response to fluctuations in the overall market. In calculating beta for a stock, data for an appropriate market index, such as the S&P 500, or the Russell 2000 is used. Analogously, the TRRU valuation model includes a risk parameter, β_{S}, which is calculated using the IAM index for the sector to which the technology belongs, IAM_{S}. Specifically, β_{S} is given by the formula

βS=Covariance(Return on TRRU, Return on IAM_{S})/Variance (Return on IAM_{S}) (8)

The risk parameter provides a measure of how changes in the computed technology value of the technology asset are correlated with fluctuations in the corresponding market sector. The TRRU model additionally includes a risk parameter β_{I}, which is defined analogously to β_{S}, using the average, IAM_{I}, of all the sector indices, IAM_{S}. The risk metrics may also be posted as part of the data describing an asset on the exchange.

### Price and Risk Metric Calculation Process

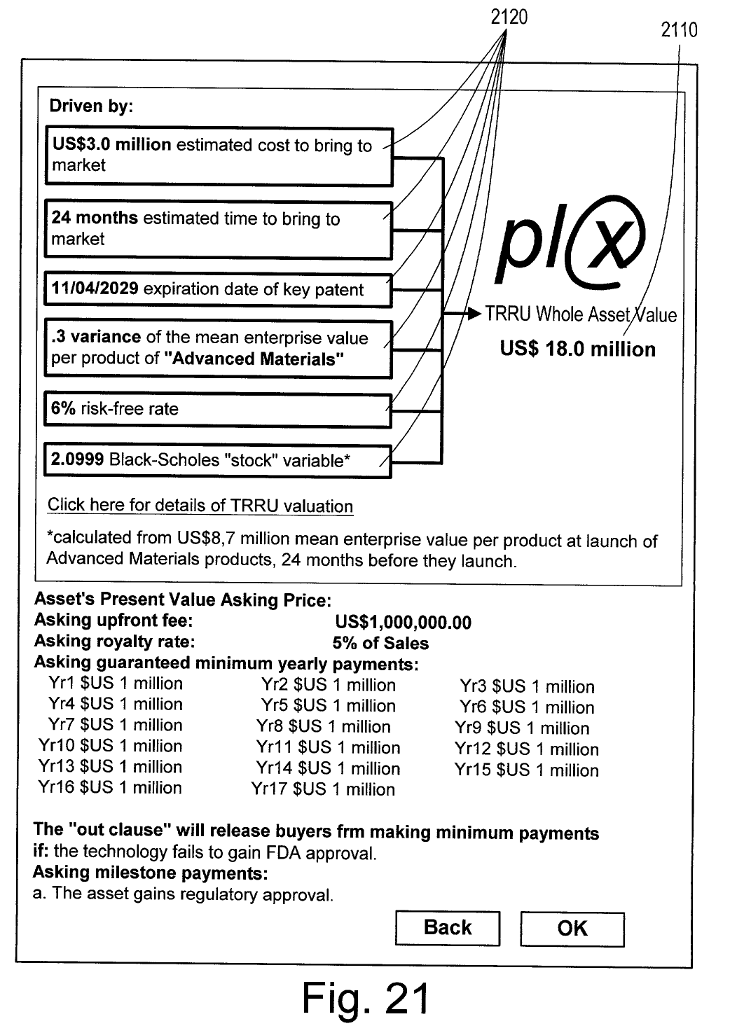

Determinations of the asking price and risk metrics, using the TRRU valuation model and price calculation method, are part of the process of stage 310A, in which the seller stores data describing the IP asset in the exchange database. The process of stage 310A, shown in FIGS. 15 and 17A-C is now described in greater detail. Values for the TRRU parameters, X, the remaining product development cost, τ. the time until a product is ready to be launched, Y_{E}, the years until expiration of the patent, and the identification of the sector and pure play category are entered in stage 311B, as shown in FIG. 18C. In stage 312A, the value for X is compared with standard values as a function of pure play category and years to launch. If the value is out of range, a message is sent to the seller and, in stage 312B, the value is adjusted or approved. Also in stage 312B, a sector and a pure play category can be assigned if none were entered in stage 311A. In stage 312C, the TRRU model total IP price is computed using Eq. (6). The TRRU value 2110 and the values of the TRRU parameters 2120 used to calculate the TRRU value are displayed to the seller as shown, for example, in the top half of FIG. 21. In stage 312D, the risk metrics β_{S} and β_{I} are computed from Eq. (8).

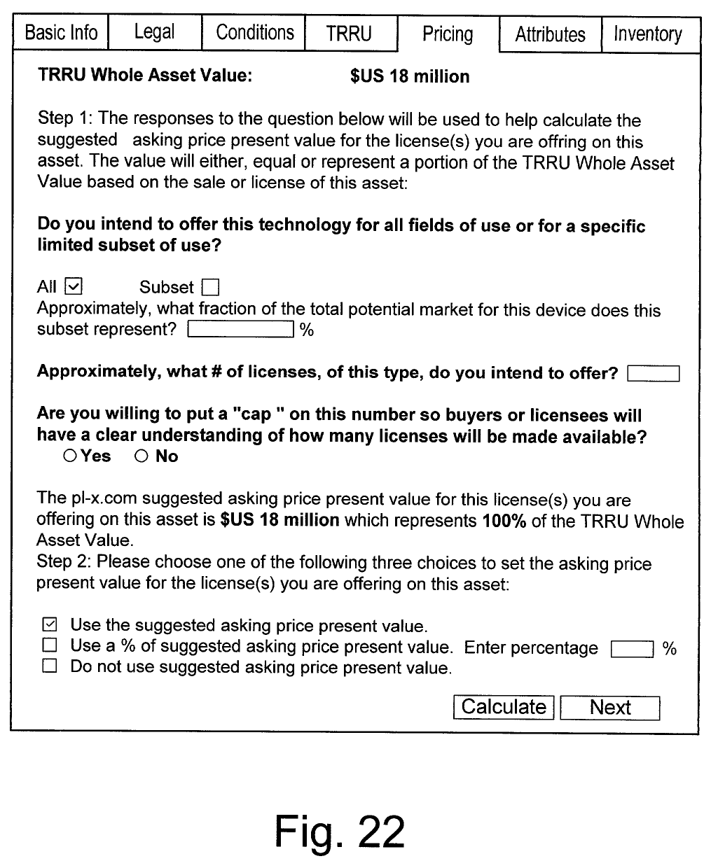

The price and posting process (stage 313) is shown in detail in FIG. 17C. In stage 313A, the seller reviews, and optionally adjusts, the TRRU model price calculated in stage 312C. Next, the calculation of the suggested asking price using Eq. (7) is performed in stage 313B. An example of the screens used by the seller in the calculation of the suggested asking price, allocated among components, is displayed in FIGS. 19 and 22. A sample display to the seller of the results of the asking price calculation is illustrated in FIG. 21. The seller may, optionally, choose to discount the asking price to a value below the output of the pricing calculation of Eq. (7) using the TRRU model price. Finally, the asking price and the risk metrics are posted on the exchange database in stage 313C. When the asking price has been set lower than value from the pricing calculation using the TRRU model price, at the seller's discretion, the display of the asking price can include an indicator to identify the asset as a discounted asset.

### Additional Applications of the TRRU Valuation Model

The TRRU valuation model provides an objective mechanism to establish a value for an intangible asset. In addition to use in valuing an IP asset as part of a sale or licensing transaction, as described above, the TRRU valuation tool has multiple applications to other types of financial transactions. First, the TRRU valuation model can be used to securitize future revenue streams of an IP asset allowing the creation of a financial instrument in future revenue that can be bought and sold analogously to a stock. Multiple assets may be bundled together for trading in the Securitized Asset Cash Flows Market, discussed further below. Second, using the TRRU valuation, IP assets can be collateralized; that is future royalty streams can be pledged as collateral in non-recourse loans. Collateralization enables newly formed companies with few tangible assets to acquire cash at an early stage. Third, the TRRU valuation model can be used to value an IP asset being donated for tax purposes. According to tax laws, in order for the giver to realize a tax benefit from his donation, a value of the donated asset needs to be established. Fourth, the TRRU valuation process provides a tool for asset prioritization within a large IP portfolio. Large companies typically have multiple technologies in early stages of development represented in their IP portfolios. Analysis using the TRRU valuation will enable rational prioritization of these technologies for new product development decisions or election of alternative actions. Such actions include donation, outlicensing, securitization, or collateralization, as disccued above. In addition, the TRRU valuation is used to establish the level of patent validity insurance in a patent and license exchange transaction.

### Patent Risk Rating and Patent Validity Insurance

A patent refers to a bounded region of intellectual property. As intellectual property is to real property and as a patent is to a real property title, so is patent validity insurance to property title insurance. This mandatory insurance product helps reduce the buyer's risk, and is one of the risk transfer elements that the exchange provides to expedite patent sales and license transactions.

Just as each patent will receive a TRRU value, risk measure (β) and price before it is posted on the pl-x.com patent market, each patent will receive automatic validity insurance at the close of a transaction. The insurance is for the benefit of the buyer. The availability of patent insurance creates a more risk-free marketplace by reducing the risk that buyers and sellers bear in each patent sale. pl-x.com is also working to create a complete package of patent insurances including Validity-based Seller-Royalty insurance, validity plus, infringement, and enforcement insurances to facilitate the safe and efficient commercial transfer of quality patents and licenses.

### Patent Validity Insurance

The patent validity insurance coverage will automatically cover every patent and license transaction closing on pl-x.com. This innovative risk transfer product will enhance pl-x.com market liquidity because each pl-x.com patent buyer or licensee will be insured for the amount of the total transaction value of each patent and license. As described previously, the total transaction value may include four payment components: an upfront fee, royalty rate, guaranteed yearly minimum payments, and milestone payments. The amount of insurance provided is based on the present value of the total transaction, typically computed as the sum of the upfront payment and the value of the future yearly minium and milestone payments discounted to the present. The discount rate is a linear function, determined by exchange financial analysts, of the TRRU metric variable σ² for the pure play category or sector corresponding to the asset being valued. The discount rate typically varies between about 0.15 and 0.45 for each pure play category.

Patent validity coverage indemnifies the buyer or licensee against the risk of financial loss that can arise when the purchased patent is declared invalid. Invalidity could be declared, for example, if the inventor or patent applicant failed to disclose information in the patent application process or because of outright fraud, such as a fictitious patent or a patent offered for sale by someone other than its owner. Coverage can be provided for the buyers' purchase price or license fees, plus tooling costs and even for investment in developing the new product from the patent rights acquired.

### Additional Patent Insurance Products

In addition to automatic patent validity insurance, coverages will be made available to cover business transacted on pl-x.com. These include (1) Patent Validity Plus for the risk of loss due to invalidity of additional amounts to be invested in product development going forward, (2) Infringement for the risk of patent infringement liability, and (3) Enforcement for a legal expenses limit for the enforcement of patent rights against others who infringe on the rights transferred.

### Exchange Escrow Operations

A degree of trust and security between buyers and sellers is needed for any transaction to take place. An entire industry has evolved that provides trust and security in real estate transactions—the third party escrow. An escrow officer holds transaction documents from one party and the cash consideration from the other, deducts costs and fees, and, upon instructions from the parties, releases the documents and cash. This service provides both parties with a high degree of confidence that the transaction will close as anticipated, and each side will receive the benefit of its respective bargain. No institutional, third party escrow service currently exists for buying and selling patents.

The patent market has a present, acute need for a neutral escrow service. For example, in order for a business development executive at an orthopedic implant company in Tennessee to acquire a license for a bone growth protein from a bioengineering company in Finland, the Tennessee buyer must feel secure and confident that the cash wired to a Finnish bank or other financial intermediary will be appropriately handled and will result in the delivery of the bone protein patent. Currently, the participants in international patent exchanges take the risk that local law and custom will protect their respective interests. However, neither the American nor the Finnish party will be willing to learn the details of international contract law nor will they take the chances on the other party following through without some kind of third-party assurance. Furthermore, the concept of hiring local legal representation is both expensive and potentially unreliable.

The patent escrow service is a third party intermediary which holds the consideration from Tennessee and the patent title from Finland, and disburses neither item to the opposite party until both have been received and verified. Furthermore, the patent escrow, in being impartial, is responsible for complying with the requirements of local law for such transfers and for the collection and payment of fees, costs and commissions. The patent escrow agent will operate under contract from the exchange, and will receive compensation for this service according to a fee schedule.

In addition to escrow, pl-x.com will provide on-line document management tools to help both parties manage the paperwork involved in each deal closing. The tools enable both parties in the deal to talk in a secure on-line space, to edit and review password-protected documents, and to track the progress of deal documentation all in a paperless environment. pl-x.com management believes that this service, originally designed for the financial community, will further reduce the time it takes to close technology transfer deals and will offer both parties increased control over the documents involved.

### Licensing Administration Operations

The exchange fills an unmet need for cost-effective after-market licensing administration. Many companies do not have a dedicated licensing department, adequate administrative budgets, or license and royalty compliance monitoring. Potential revenue is lost.

The exchange licensing administration service uses a powerful information technology network for processing, tracking, and reporting royalties. This service is executed in cooperation with the exchange escrow service. A patent buyer will respond to a royalty questionnaire which will be based on the transaction terms agreed to at closing and that were filed with the exchange escrow service. The questionnaire will be processed electronically, reviewed by the exchange staff for inconsistencies, and then forwarded to the seller for acceptance. After the report has been accepted by the seller, the buyer will immediately receive wire instructions to deposit the appropriate royalty into a special bank account maintained for the benefit of the exchange escrow service. Simultaneously, the escrow service is notified to expect the wire. The escrow service, in turn, immediately confirms receipt of the funds and is responsible for wiring the funds to the seller.

### Financial Operations for the Options Market

The options market, the second of the three the exchange patent markets, allows for trading in both call and put options, so long as market participants (companies or third-party hedgers) are willing to offer them. Different motivations for trading are expected to arise depending on who is buying and selling each type of option.

### Options Traded Between Other Sellers and Buyers

### Call Options

A patent call option is the contractual right to purchase a technology from its owner at a predetermined price before a set expiration date. Buying the technology for the predetermined price is referred to as “exercising” the option, and the “exercise price” tends to be similar to the price that would be charged for exclusively licensing the technology outright from the beginning. Owning a patent call option gives the assurance that no competitor will be able to buy or license the technology until the option either expires or is exercised.

A risk-averse corporate entity, with an interest in a particular patent listing, may want to purchase a call option before beginning experiments or clinical trials to see if the technology works. If the technology development is successful, the entity exercises its option and owns the patent license. If it fails to meet the entity's requirements, or if the entity's business changes during the development, the option is allowed to expire, having spent much less money than it would have had it bought or licensed the patent outright from the beginning.

The patent owner who issues, that is “writes”, the option also benefits: If the option buyer decides it likes the technology and exercises its option, the option writer receives the exercise price (normally equal to a comparable license fee if the technology were licensed outright from the beginning) plus the option price it collected when the option was written. If the buyer decides not to exercise the option, the writer keeps the option price it collected and it keeps 100% ownership of the patent, on which it can go on to offer another option to another market participant. Thus, there is a clear motivation for both call option buyers (corporate developers), and call option writer (university with patents lying fallow), to trade in this way.

### Put Options

There is little motivation for a corporate developer to buy a put option (the right to sell a patent listing back to the original owner for a predetermined price) if call options are offered, since buying the technology plus a put is equivalent to buying a call and loaning the patent research institution cash. The put writer's motivation is to convince a buyer to buy the patent, and to get a cash “loan.”The price of the put option is normally proportional to risk of failure of the technology. When the risk is very high, the put option price will approach the present value of the exercise price, (exercise price)/(1+risk free rate)ⁿ. Similarly, the exercise price would be a function of the purchase price of the patent, and when the risk is very high would approach the future value of the purchase price, (purchase price) (1+risk free rate)ⁿ. In the hypothetical extreme case, where both parties know there is no chance of the technology working, the put price become equal to the purchase price and the strike price becomes the future value of this figure at the risk-free interest rate—buying a put option would be like buying a government bond.

### Options Traded Between Other Parties

### Call Options

A fraction of a call option can be bought by a second corporate developer if the first developer is cash-limited and is willing to split the eventual ownership of the product by a predetermined percentage. The second corporate developer may have heard about the technology late and want to get at least part of it. The first developer could list this “fractional call option” back on the same exchange where it found it.

Alternatively, a developer in need of cash who is working on a high-profile technology could offer minute fractions of a call option to the public. This can be done, whether the developer bought the call option from a patent option writer, or is creating the option from its own endogenous technology. This kind of “patent option offering” is analogous to a public equity offering, only the company offering the patent equity is doing so with the understanding that it may decide to “go private” at some predetermined date several years in the future—buying back all the pieces of the call, at a premium, if the technology works out. It is feasible that the company could afford such a cash outlay, which could be much larger than the cash it received when it sold the patent calls to the public in the first place, because it will be better able to raise cash through other means once it has a workable product. This is a high-risk form of investment, since the public has no assurance that the developer will do its best to develop the patent, and the eventual value of the patent call option is related to the patent's development.

### Put Options

A third-party nay-sayer may have reason to buy a put option from a corporate developer who bought it from the original owner. Although the put option cannot be exercised without the patent, the third party nay-sayer may feel confident that the developer will fail at developing the technology, and therefore need to get the put option back in order to “put” the patent back to the original owner. In this case, the developer would be forced to buy the put option back from the third-party nay-sayer, at a free-floating price that would obviously be higher than the price the nay-sayer paid for it (but always lower than the exercise price). The nay-sayer would therefore have won his “bet” and profited. The nay-sayer buyer would want to know the exercise price of the option from the very beginning even though he can never exercise it, because this is the upper limit of his pay-back.

### Valuation in the Options Market

Relevant factor for pricing options on intellectual property are all included in the five inputs to the Black-Scholes model. The “S” input into the conventional Black Scholes option pricing model, Eqs. (1) and (2), is, conveniently, also equal to the exchange's TRRU value and, where appropriate, the adjusted price for purchasing the technology outright.

Suggested values are posted next to each option listed on the options market, similar to the procedure in the license market. Valuation of technology that underlies each option is the first step, and is performed in exactly the same way as in the license market.

### Financial Operations for the Securitized Asset Cash Flows Market

The most complex of the three exchange markets, the Securitized Asset cash flows markets allows for the buying and selling of small pieces of groups of technologies bundled together. Securitized Asset cash flows unit trading is the only example of the exchange transactions that are only occurring between buyers and sellers in off-exchange private negotiated deals. The most famous of these recently is the securitization of the cash flows of David Bowie records—known within the industry as Bowie Bonds. IP holders may bundle a group of technologies, “securitize” them into units, and lists these units, or options to own the units, on the Securitized Asset cash flows exchange.

Large research institutions may be the most likely candidates to offer Securitized Asset cash flows, as they have large quantities of related patents that would lend well to a Securitized Asset cash flows format.

### Valuations in the Securitized Asset Cash Flows Market

The suggested value for each listed Securitized Asset cash flows unit is analogous to the book value typically listed for each REIT (Real Estate Investment Trust) unit in today's REIT market. Each patent property bundled together in a particular Securitized Asset cash flows is evaluated according to the methodology described above. The sum of these values is then divided by the number of shares outstanding in the Securitized Asset. This technology “book value” is then listed on the Securitized Asset cash flows exchange next to each Securitized Asset. The actual bid and ask price for each Securitized Asset is determined by supply and demand in typical market-price discovery fashion, just as the case with REITs, or for that matter, assets on the other markets of the Exchange And, as with REITs, market price and book value are often disparate. The posted book value of Securitized Asset cash flows, however, changes more frequently than the posted book value of REITs, since the exchange Financial Operations TRRU Metrics algorithms constantly update the suggested price of all units of patent pertinent to each Securitized Asset.

### Data Sources

For purposes of re-calibrating the exchange valuation coefficients, “data” consists of examples of real-world intellectual property transactions in which both the nature of the technology and the purchase price are disclosed. Such data is critical for continually refining our valuation model, as described above. Data for this purpose is continually generated by buyers and sellers and fed back into the exchange model. Prior to trading on the exchanges, however, data is to be tabulated from press releases, from trade publications that feature technology transfer deals, and from companies and research institutions themselves.

### Auction Function

The exchange auction web site supports the following functions.

Initial Buyer/seller Registration

This step deals with issues relating to authentication of trading parties, exchange of cryptography keys, and the creation of a profile for each trader that reflects his/her interest in specific patent.

Setting up a Particular Auction Event

This second step includes describing the item being sold or acquired and setting up the rules of the auction. The auction rules explain the type of auction being conducted (open cry, sealed bid, Dutch), parameters negotiated (price, delivery dates, terms of payment, etc.), starting date and time of the auction, auction closing rules, etc.

Bidding

The bidding step implements the bid control rules of the auction (minimum bid, bid increment, deposits required with bids) and for open cry auctions, notifies the participants when new high bids are submitted.

Evaluation of Bids and Closing the Auction

This step implements the auction closing rules and notifies the winners and losers of the auction.

Trade Settlement

This final step covers communicating the terms of the transfer and the next steps required for clearing the sale and securing transfer of patent rights for terms of sale.

### Auction Formats

### Open Cry

Open cry auctions take the public meeting approach. In this approach the response to each bid, for example, a higher counter-bid by another party, or the decision to close the auction, happens in a short time, sometimes in a few seconds. These auctions allow prospective buyers to: participate in the auction at the same time; and feel comfortable making counter bids in a few seconds. Traditionally such auctions are conducted with all participants present at the same location such as meeting/auction room where inter-party communication is instantaneous. Remote participation by phone and through proxy (order bid) is limited.

### Sealed Bid

Sealed bid auctions are practiced when it is impractical for the bidders to prepare counter bids instantaneously. This could be because it takes time to prepare a counter bid, the prior bid information needed to prepare the counter bid, such as the prior bid, can not be disseminated to the other bidders instantaneously, or because the bidders are not available to participate in the auction at the same time. In single round sealed bid auction, all bidders submit their bids by a deadline, and the bids are evaluated at this deadline. In multi round sealed bid auctions, there is a deadline for each round of bids, and at that deadline either the auction is closed or a fresh round of bids is solicited by some new deadline.

### Single and Multiple Round Sealed Bid

Single round sealed bid auctions lack the competitive atmosphere (bidding frenzy) in open cry auctions which encourages the bidders to outbid their rivals. Multiple round sealed bid auctions recreate some of the intensity and interest of the open cry format, however, this auction can be held over an unlimited time period until the ask price is met.

### Bulletin Board Bid

Another bidding alternative, and one that is ideally suited to IP with only limited appeal, is to use an electronic bulletin board approach. Information about the prior bids is published on the bulletin board—in this case, the Exchange's database—but new bids are not required in seconds. The bidders can monitor the bulletin board a few times a day for a few days, and they have a chance to offer counter-bids to the existing highest bid. This approach alleviates the communication latency and simultaneous participation requirement of the open cry auction, but retains its competitive nature.

### Control of Bids/Offers

In an auction, the initiator of the auction or the exchange can either require the participants to submit bids or announce its own bids to see if there are participants willing to conduct trade at his bid price. When the participants provide the bids in open cry or bulletin board auction, each successive bid is higher than the previous one.

When the exchange auction master puts up the bids, he can either start with a high bid, perhaps at which no bidder is willing to trade, and lower the bid gradually until he has sufficient bidders to clear his inventory. This is the Dutch auction in real time. Alternatively he can start at a low bid, low enough at which there are more buyers than his inventory, and increase his bid until the number of buyers willing to buy his merchandise matches his inventory. Last, with IP, the preferred method of operation is to allow the Seller to control the auction or price discovery process.

### Setting the Trading Price

Once the bidding phase is over, the bidders with the highest bids get the patent being auctioned. But the price they pay could be the same as what they bid or lower. In Discriminative Auction, also known as Yankee Auction, the bidders pay their actual bid amounts. When the bidders are repeat customers of the seller, dissatisfaction among the bidders who have to pay a higher price compared to other bidders is sometimes of concern. This is addressed by allowing the bidders with winning bids to pay the price paid by the winning bidder with the lowest bid.

This latter policy is widely known in literature as Dutch Auction, but we will refer to it as a Non discriminative Auction, because the term Dutch Auction is also widely used to describe auctions where the exchange starts with a high price and bids the price lower while buyers have the option of buying the items at any time at the current bid price. Non-discriminative auctioning is widely used by corporations to repurchase their shares (though it is referred to as Dutch auction in this context).

A variation of the Non discriminative auction called Vickrey Auction was proposed by 1996 Economics Nobel laureate, William Vickrey. Here the winning bidder pays the price bid by the highest non winning bidder. This policy is stated to create a disincentive for speculative bidding and encourage the bidders to submit bids reflecting their true value for the item being auctioned.

### Additional Auction Policy Variations

Each of the following policy choices is applicable to several, if not all, auction methods described above.

### Anonymity

Many factors go into deciding what information about bids should be made available to bidders before and after the closing of the auctions. In an open cry auction, one could conceal the identity of the bidders, or conceal the association between the bidders and the bids. In sealed bid auctions, the identity of the bidders and/or their bids could be revealed to other bidders after the close of auction. Alternatively, only the winning bids and/or bidder's identity could be revealed. Given the deep pockets of potential bidders, it may be prudent to protect the identity of all bidders to prevent a lack of bidding from smaller, less well funded bidders.

### Restrictions on Bid Amount

In all auctions the seller can specify the minimum starting bid. When auctions of the same kind of item happen regularly, the minimum bid is usually some fraction (70%) of the lowest winning bids averaged over a specified number of preceding auctions. To speed up the bidding process, minimum bid increments are often enforced. The bid increment is roughly proportional to the current bid, i.e., they are smaller for lower bids and larger at higher bids.

### Rules for Closing the Auction

Open cry auctions can finish by a posted closing time. Alternatively, the auctions can be kept open until new bids continue to arrive within some time interval of the preceding bid. One could also choose to close the auction if either of the above two conditions is met or only when both conditions are met. Dutch auctions could close at a pre specified time, when all the inventory has been sold, when the price has fallen to a pre specified level, or at some combination of these three conditions. This format is likely to be the winning formula for the exchange and its patent exchange.

### Evaluation Rules and Breaking Tied Bids

All auctions will have some rule for evaluating bids. When an item is being sold in an auction, generally a higher bid would be better than a lower bid. But other factors such as terms of payment can factor in a comparison of two bids. For example, a bid requiring delivery of goods on a schedule convenient to the seller may be preferred over another bid that matches the first one in all respects but has a delivery schedule inconvenient to the seller. Advance payment or payment on delivery may call for a higher valuation of the bid compared to a bid where payment is due within 90 days of delivery.

If multiple bids tie at the same value and the available inventory can satisfy some but not all of the bids, tie breaking rules are required. Preference may be given to bids that are for larger quantity, and in case of two bids specifying the same quantity preference could be given to the bid that arrived earlier. If the seller maintains a history of its auctions, it can give preference to the bidder with whom he had better business dealings in the past.

### Services Provided to Sellers and Bidders

Reserve prices (hidden lower limit on price acceptable to seller) is one service that the exchange can provide to the seller. Other high-value services will include a credit check and certification of all bidders, patent insurance to prevent against patent default, escrow and clearing services. Order bid (bidding through the exchange provided proxy to a qualified Licensing Agent) is an important service that the exchange can provide to the bidders. Alerting registered bidders to upcoming auction events and hosting special auction events are other marketing services that help create an efficient marketplace.

### Security Considerations

Security mechanisms are needed to ensure that the site announcing the auction and its rules is not sabotaged by an outsider. This includes preventing unauthorized postings and alterations as well as preventing denial of service attacks. Cryptographic tools that prove that a particular auction notice was posted and accessible during a certain time period will be very useful.

During the bidding phase cryptographic tools will ensure that a bid submitted is not tampered with and that it is not disclosed to other bidders in violation of the auction rules. In open cry auctions, a verifiable connection from every bid to a known bidder will demonstrate chain of bid for verification.

### Terms and Conditions

The exchange bidding process allows the buyers to request specific payment or shipping terms, these terms and conditions will be treated as part of the bid. The auction chart will display the offered terms and conditions along side the bids shown. Further, when creating the product description, the seller will specify the range of terms and conditions acceptable to him and indicate how they are factored in bid evaluation.

### Retraction of Auction and Bids

During the bidding phase, under certain conditions the seller may be allowed to stop or withdraw the auction or modify the rules. Similarly, under certain conditions the bidders will be allowed to withdraw or modify their bids.

### Closing the Auction

The auction close according to the closing rules specified. At this time, the winning bids can be treated as, and if needed translated to, traditional purchase orders. At the closing of the auction, the following additional activities need to take place.

### Notification

The exchange must communicate the results of the auction to the bidders. Depending on the auction policy, some information will be made available publicly, some common information will be made available to all bidders, and some will be communicated only to bidders to whom it is relevant. Once again security and privacy tools are needed.

### Record Retention

To prove to the bidders and the seller that the auction was conducted fairly, the auction record is digitally signed by the exchange.

Embodiments described above illustrate but do not limit the invention. In particular, the invention is not limited to any particular hardware/software used to implement the computer system of the present invention.

In the preferred embodiment, the seller maintains a high degree of control in closing the auction for the seller's intellectual property. At the time of inventory posting, the seller designates the rules for selecting the auction winner. Such rules may include highest cash price, highest royalty rate, highest bid within a specified time period, or some other parameter or combination of parameters determined exclusively by the seller.

We claim:

1. A computer system for providing a valuation of an intellectual property asset, the computer system comprising:
at least one server computer connected to one or more client computers via a global-area network; and
a computer program executed by the server computer;
wherein the computer program further comprises computer instructions for:
storing information about the intellectual property asset in a database, the information comprising a technology classification;
storing information about publicly traded securities according to the technology classification in the database; and
generating a valuation based on call option pricing theory, using the information about the intellectual property asset and the information about the publicly traded securities stored in the database,
wherein the intellectual property asset is stored on an exchange database associated with the server computer and the valuation is related to the amount of insurance provided in a transfer of intellectual property rights to the intellectual property asset.

2. A computer system for enabling an exchange of rights to an intellectual property asset between a buyer and a seller, the computer system comprising:
at least one server computer connected to one or more client computers via a global-area network; and
a computer program executed by the server computer;
wherein the computer program further comprises computer instructions for:
storing information about the intellectual property asset in a database, the information comprising a technology classification;
storing information about publicly traded securities according to the technology classification in the database;
generating a valuation based on call option pricing theory, using the information about the intellectual property asset and the information about the publicly traded securities stored in the database;
storing information about a term of the intellectual property asset and about licensing conditions offered by the seller in the database;
generating a suggested asking price based on the valuation and the licensing terms; and
enabling the seller to modify the suggested asking price to determine an offering price.

3. The computer system of claim 2 wherein the computer program further comprises instructions for providing to a potential buyer a description of the intellectual property asset, the offering price, and a discount indicator when the offering price is less than the suggested asking price.

4. A computer system for storing information about intellectual property assets, the computer system comprising:
at least one server computer connected to one or more client computers via a global-area network; and
a computer program executed by the server computer;
wherein the computer program further comprises computer instructions for:
translating quantitative information about attributes of a technology described by the intellectual property assets from user defined units to standard scientific units; and
storing user defined units and the quantitative information in standard scientific units.

5. The computer system of claim 4 wherein the quantitative information for each attribute comprises a description of the attribute, a minimum value of the attribute achieved by the technology, and a maximum value of the attribute achieved by the technology.

6. The computer system of claim 4 wherein the computer program further comprises instructions for translating quantitative information in standard scientific units to user defined units for display to the user.

7. A method for creating financial value from an intellectual property asset using a computer system comprising at least one server computer and one or more client computers connected to the server computer via a global-area network, the method comprising:
storing information about the intellectual property asset in a database, the information comprising a technology classification;
storing information about publicly traded securities according to the technology classification in the database;
generating a valuation based on call option pricing theory, using the information about the intellectual property asset and the information about the publicly traded securities stored in the database; and
creating a tradable security based on the intellectual property asset wherein the price of the security is based on the valuation.

8. A method for creating financial value from an intellectual property asset using a computer system comprising at least one server computer and one or more client computers connected to the server computer via a global-area network, the method comprising:
storing information about the intellectual property asset in a database, the information comprising a technology classification;
storing information about publicly traded securities according to the technology classification in the database;
generating a valuation based on call option pricing theory, using the information about the intellectual property asset and the information about the publicly traded securities stored in the database; and
using the intellectual property asset as collateral for a loan wherein the value of the asset is based on the valuation.

9. A method for creating financial value from an intellectual property asset using a computer system comprising at least one server computer and one or more client computers connected to the server computer via a global-area network, the method comprising:
storing information about the intellectual property asset in a database, the information comprising a technology classification;
storing information about publicly traded securities according to the technology classification in the database;
generating a valuation based on call option pricing theory, using the information about the intellectual property asset and the information about the publicly traded securities stored in the database; and
realizing a reduction in tax obligation by donating the intellectual property asset, wherein the reduction is based on the valuation.

10. A method for intellectual property asset management using a computer system comprising at least one server computer and one or more client computers connected to the server computer via a global-area network, the method comprising:
storing information about intellectual property assets in a database, the information comprising technology classifications;
storing information about publicly traded securities according to the technology classifications in the database;
generating valuations based on call option pricing theory, using the information about the intellectual property assets and the information about the publicly traded securities stored in the database; and
using the valuations of the intellectual property assets as a basis for management decisions.
